(19) United States
(12) Patent Application Publication
(10) Pub. No.: US 2025/0284120 A1
(43) Pub. Date: Sep. 11, 2025

(54) Photonic Integrated Circuits with Grating Couplers Emitting Low Divergence Beams on or adjacent to Movable Platforms for Augmented Reality Glasses and LiDAR

(71) Applicant: Max-Planck-Gesellschaft zur Foerderung der Wissenschaften e.V., Munich (DE)

(72) Inventors: Wesley Sacher, Halle (DE); Jared Carl Mikkelsen, Mississauga (CA)

(73) Assignee: Max-Planck-Gesellschaft zur Foerderung der Wissenschaften e.V., Munich (DE)

(21) Appl. No.: 19/073,305

(22) Filed: Mar. 7, 2025

Related U.S. Application Data
(60) Provisional application No. 63/562,413, filed on Mar. 7, 2024.

(51) Int. Cl. G02B 26/10; G01S 7/481; G02B 27/01

(52) U.S. Cl. CPC G02B 26/106; G01S 7/4817; G02B 27/0172; G02B 2027/0112

(57) ABSTRACT

Laser-scanning systems for augmented reality glasses displays and LiDAR (light detection and ranging) use photonic integrated circuits to generate multiple collimated (or low-divergence) modulated laser beams. Laser light is guided on the photonic chip, expanded, and emitted from the surface of the chip (using grating coupler devices) as one or more large-diameter (e.g., millimeter-scale), collimated or low-divergence beams. These gratings may be integrated onto movable microelectromechanical systems (MEMS) plates to steer the beam along two angular axes. Alternatively, the beam(s) from the grating(s) may be steered by a separate MEMS mirror integrated onto the photonic chip or on another chip. Such systems enable multi-beam laser scanning systems without collimation lenses, reducing the size and packaging complexity of high-performance laser scanning systems for augmented reality glasses and LiDAR.

### CROSS-REFERENCE TO RELATED APPLICATION(S)

This application claims the priority benefit, under 35 U.S.C. 119(e), of U.S. Application No. 63/562,413, filed Mar. 7, 2024, which is incorporated herein by reference in its entirety for all purposes.

### BACKGROUND

Head-mounted displays and near-eye displays for augmented reality (also referred to as mixed reality or extended reality) are transparent (see-through) glasses that overlay images generated by light engines onto the user's field of view (FOV). The light engines are typically on the periphery of the glasses and the light is guided and directed toward the user's eyes using optical combiners. An optical combiner is an optical device placed close to the eye(s) of a user, allowing the user to see augmented content, such as text or images, as well as the real world behind the optical combiner in the viewing direction of the user, at the same time. The size and weight of the optical components and systems are critical to head-mounted displays.

Laser-scanning light engines have become the focus of a growing number of commercial efforts for head-mounted displays. Laser-scanning has advantages of increased brightness, image contrast, and power efficiency compared to panel microdisplays.

The laser-scanning approach has multiple performance trade-offs and limitations, including:
1. For fixed fast axis mirror frequency and maximum laser modulation rate, there is a trade-off between FOV and resolution, i.e., for each displayed frame, there is a maximum number of resolvable spots that can be defined due to the limited mirror and laser modulation speeds.
2. There are practical limitations on the fast axis mirror frequency. Increasing the fast axis mirror frequency requires a reduction in mirror size, and hence, a reduction in beam size. This increases the divergence of the beam and compromises the operation of the optical combiner—both reducing the resolution. >2 mm beam diameters are typically required for high resolution. ˜30 kHz mirror frequencies are the current state of the art but typically require ˜1 mm diameters.
3. There are also practical limitations on laser modulation rates. ˜250-500 MHz are typical practical modulation rates. Higher-speed operation would require complex drive electronics (including high-speed digital to analog converters), and in addition, modulation rates >1 GHz may be limited by the relaxation resonance frequency of the lasers.
4. The light engine is complex, has a complicated packaging procedure, and is difficult to miniaturize. There are many free-space optical components that are aligned and packaged together.

Scanning multiple laser beams (“multi-beam scanning”) is one way to alleviate the limitations due to the MEMS mirror fast axis frequency. In multi-beam scanning, multiple beams scan the FOV in parallel, multiplying the number of lines scanned per cycle of the fast axis, and the resolution scales with the number of beams. Conventional techniques to multi-beam scanning involve increasing the number of lasers in the light engine, which further increases the size, complexity, and packaging/assembly difficulty.

As an example of the limitations of the laser-scanning display approach, achieving a resolution of 2000 pixels×2000 pixels with a state-of-the-art FOV of 36°×36° (50.9° diagonal, state-of-the-art FOVs are ˜50° diagonal) at a 120 Hz frame rate involves a fast axis mirror frequency of about 120 kHz and a laser modulation bandwidth of ˜1 GHz (2 ns per pixel addressing time). The mirror frequency is incompatible with a mirror diameter >0.5 mm, and the laser modulation rate would be challenging to achieve due to the complex electronics and the size limitations of head-mounted displays.

Light detection and ranging (LiDAR) uses light for three-dimensional imaging, often using invisible near infrared (NIR) light with typical wavelengths around 850 nm, 905 nm, or 1550 nm. Miniaturized LiDAR systems are used in automotive sensor and mobile device applications. LiDAR is also used in augmented reality glasses, which map the surroundings of the user such that displayed images/video are in context to those surroundings.

LiDAR based on laser scanning (where a laser beam is scanned across the scene) has better resolution and contrast than flash methods (where the entire scene is illuminated at once and a pixelated sensor detects the return). In laser scanning LiDAR, the laser beam is modulated (e.g., pulsed/periodically modulated in amplitude or chirped in frequency) and differences in the arrival time/amplitude/frequency of reflected light collected by the LiDAR system enable depth measurements. Laser scanning LiDAR systems are often assemblies of discrete optical components (including lasers, MEMS mirrors, lenses, and photodetectors, like the light engines for display discussed above), posing challenges related to miniaturization and complexity of packaging/assembly. In addition, the MEMS mirrors in such systems limit the resolution, FOV, and frame rate, with faster MEMS mirrors being limited to smaller diameters (resulting in larger beam divergences and lower resolutions).

Scanning multiple beams can alleviate limitations from the MEMS mirrors, but requires multiple lasers and detection paths, increasing the size and complexity of LiDAR systems based on discrete components. Photonic integrated circuits hold promise for miniaturization and reducing packaging complexity of LiDAR systems. LiDARs based on optical phased arrays become enormously complex for ˜1 mm scale beams and may involve hundreds to thousands of phase shifters, and such demonstrations have been limited in their FOV and resolution compared to conventional LiDAR system based on MEMS mirrors.

### SUMMARY

An inventive photonic integrated circuit chip includes a substrate, movable plate, array of lasers, array of waveguides, slab waveguide, grating, and actuator(s). The movable plate is suspended from the substrate and configured to tilt about first and second axes with respect to the substrate. The array of lasers is integrated with the substrate and configured to emit red, blue, and green light; The array of waveguides is integrated with the substrate in optical communication with the array of lasers and guides the red, blue, and green light to the movable plate. The slab waveguide is integrated with the movable plate and guides the red, green, and blue light. The grating is integrated with the movable plate in optical communication with the slab waveguide and emits the red, green, and blue light into free space. And the actuator is operably coupled to the movable plate and tilts the movable plate about the first and second axes so as to scan the red, green, and blue light across at least a portion of a field of view.

The substrate may form an outer frame around the movable plate, in which case the photonic integrated circuit chip further includes an inner frame suspended from the substrate and configured to tilt about the first axis with respect to the substrate. The movable plate is suspended from the inner frame and configured to tilt about the second axis with respect to the substrate and the inner frame. Such a photonic integrated circuit chip can also include a conductive coil, integrated with the inner frame, to cause two-dimensional rotation of the movable plate via the Lorentz force in response to a current and an applied magnetic field. It can also include inner torsion springs mechanically coupling the movable plate to the inner frame and outer torsion springs mechanically coupling the inner frame to the outer frame.

The slab waveguide can form the red, green, and blue light into multiple beams of red, green, and blue light, respectively. In this case, the grating can emit the beams of red, green, and blue light into free space and the actuator and movable plate can scan the beams of red, green, and blue light across different slices of the field of view.

The grating can be apodized, curved in a plane of the movable plate, and/or configured to emit the red, green, and blue light as collimated beams.

The grating can include cladding material and first and second layers of grating teeth embedded in the cladding material. The first and second layers of grating teeth diffract first and second portions, respectively, of the red, blue, and green light into free space at first and second angles, respectively, with respect to the movable plate.

In some cases, the slab waveguide is a first slab waveguide configured to guide first portions of the red, green, and blue light and the grating is a first grating configured to emit first portions of the red, green, and blue light into free space in first directions. In these cases, the photonic integrated circuit chip can also include a second slab waveguide, integrated with the movable plate in optical communication with the array of waveguides, to guide second portions of the red, green, and blue light and a second grating, integrated with the movable plate in optical communication with the second slab waveguide, to emit the second portions of the red, green, and blue light into free space in second directions. The first slab waveguide can overlap the second slab waveguide, and the first grating can overlap the second grating.

The actuator(s) may include cantilevered piezoelectric actuators coupling the movable plate to the substrate and configured to rotate the movable plate about the first axis and the second axis.

The array of lasers can also emit infrared light, in which cases the array of waveguides can guide the infrared light to the movable plate, the slab waveguide can guide the infrared light to the grating, and the grating can emit the infrared light into free space. In these cases, the photonic integrated circuit chip can also include at least one photodetector, in optical communication with the grating, to detect returned infrared light from an object illuminated by the infrared light.

The photonic integrated circuit chip can be part of a light engine for an augmented reality display. This light engine can also include a waveguide combiner, in optical communication with the photonic integrated circuit chip, to direct the red, green, and blue light emitted into free space by the grating, optionally off a mirror, toward an eye of a person viewing the augmented reality display. The array of lasers in such a light engine can emit infrared light, which the array of waveguides can guide to the movable plate. The slab waveguide can guide the infrared light to the grating, which can emit the infrared light into free space. The waveguide combiner can transmit the infrared light onto a scene, and the light engine can include at least one photodetector to detect returned infrared light from the scene.

An alternative photonic integrated circuit chip can include a substrate, movable plate, array of lasers, array of waveguides, slab waveguide, grating, actuator(s), and photodetector(s). The movable plate is suspended from the substrate and configured to tilt about first and second axes with respect to the substrate. The array of lasers is integrated with the substrate and can emit infrared light. The array of waveguides is integrated with the substrate in optical communication with the array of lasers and can guide the infrared light to the movable plate. The slab waveguide is integrated with the movable plate and can guide the infrared light from the array of waveguides. The grating is integrated with the movable plate in optical communication with the slab waveguide and can emit the infrared light into free space. The actuator is operably coupled to the movable plate and can tilt the movable plate about the first and second axes so as to scan the infrared light across at least a portion of a field of view. And the photodetector is in optical communication with the grating and can detect returned infrared light from an object illuminated by the infrared light. This photonic integrated circuit chip can be part of a LiDAR system, e.g., with a fixed or moving mirror that reflects the infrared light.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A illustrates an inventive photonic integrated circuit chip, also called a photonic chip. The chip includes integrated red (R), green (G), and blue (B) lasers (possibly flip-chip bonded). The lasers are directly-modulated to encode pixel brightness. Each laser is coupled to a waveguide on the photonic circuit chip, and an example cross-section of a silicon nitride (SiN) waveguide is shown. Each waveguide is routed and coupled to a slab waveguide. Light propagates in the slab and expands in the chip-plane. Light in the slab is then radiated out of the chip plane by a grating with a relatively weak grating strength to achieve a large beam diameter (e.g., about 0.5 mm to about 3.0 mm) with low divergence (e.g., full divergence angles of about 0.005° to about) 0.05°. Multiple subsets of RGB waveguides may be coupled to the slab, each corresponding to a different propagation angle in the slab, resulting in multiple independent beams emitted from the chip at various angles.

The slab and grating are on a movable plate that can rotate along two axes (slow and fast axes), continuously steering the light in two angular dimensions. For example, the movable plate may scan the beam along one axis (the fast axis) at a frequency of about 5-30 kHz and along another axis (the slow axis) at a frequency of about 60 Hz to hundreds of Hz (possibly up to several kHz for Lissajous scanning). The movable plate may produce mechanical deflection on an axis without FOV splitting of about ±5° to about ±15°; with FOV splitting, the mechanical deflection may range from about ±0.5° to about ±7.5°, depending on the amount of FOV splitting.

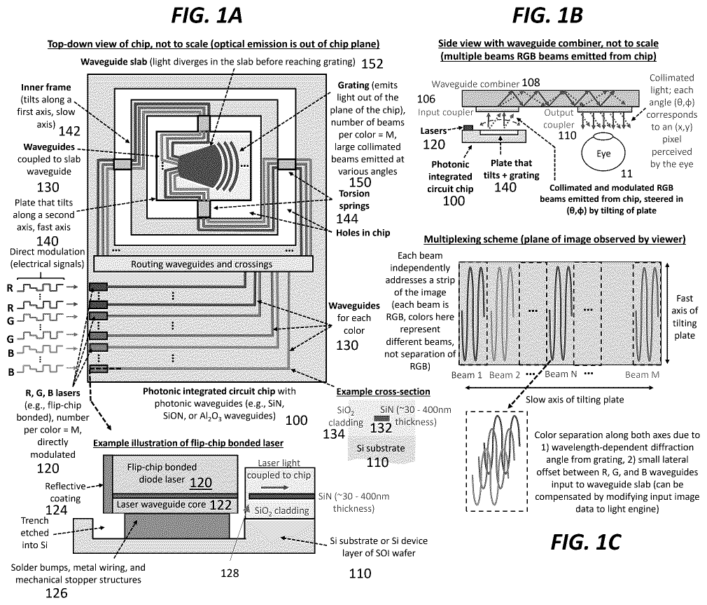

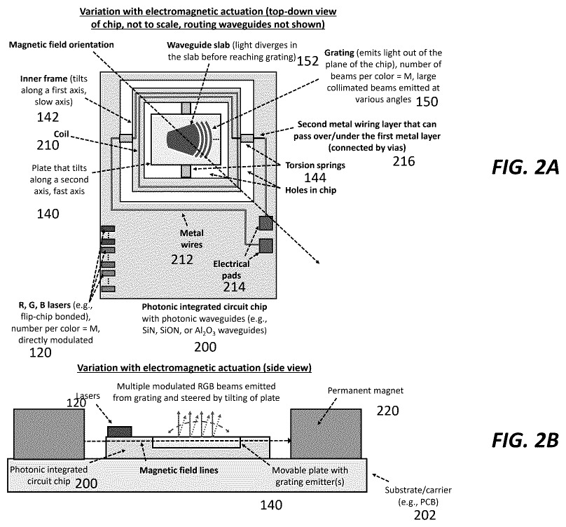

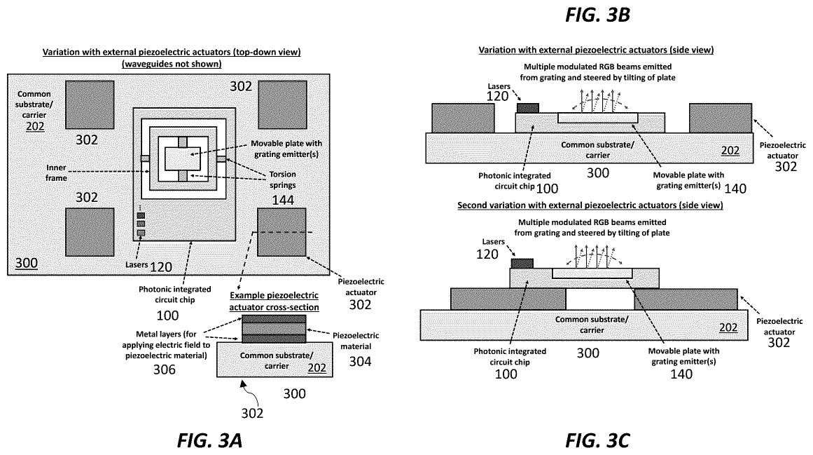

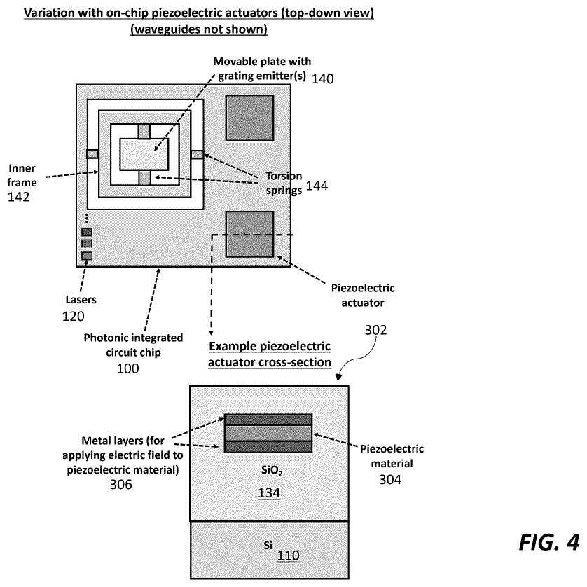

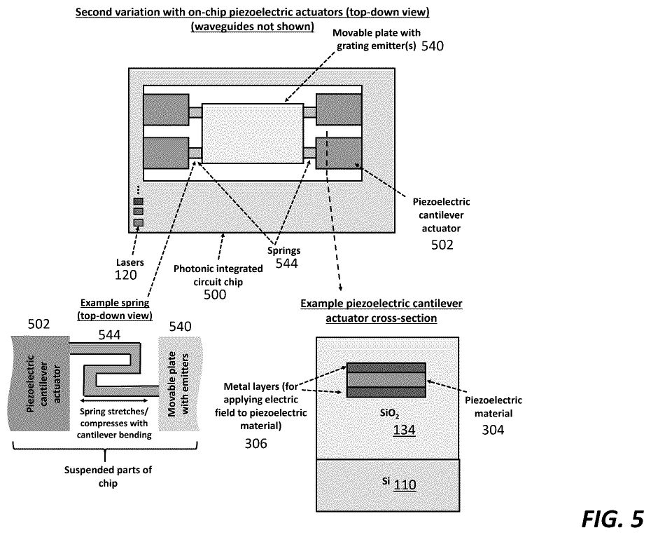

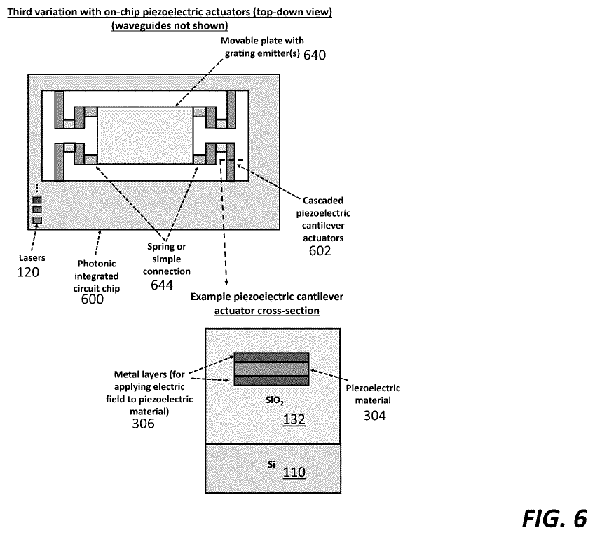

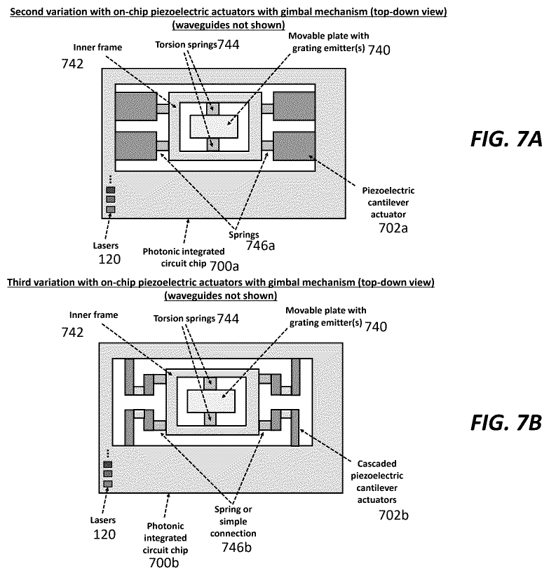

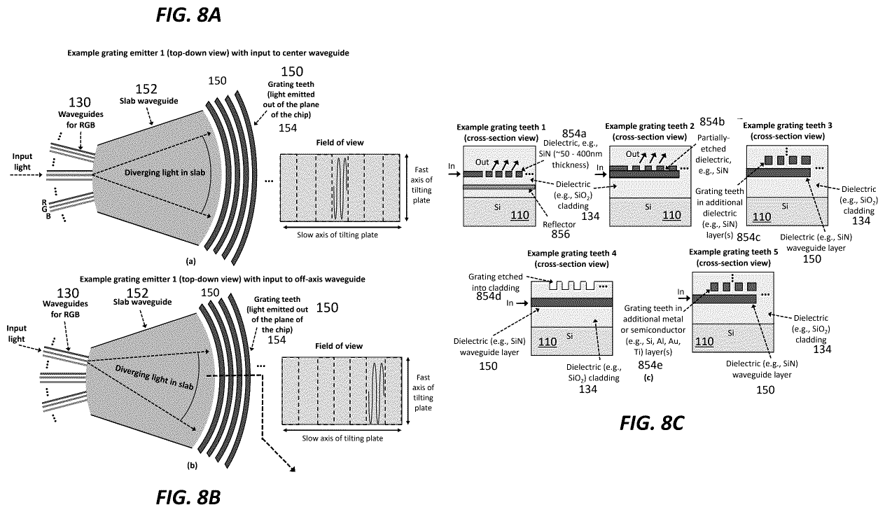

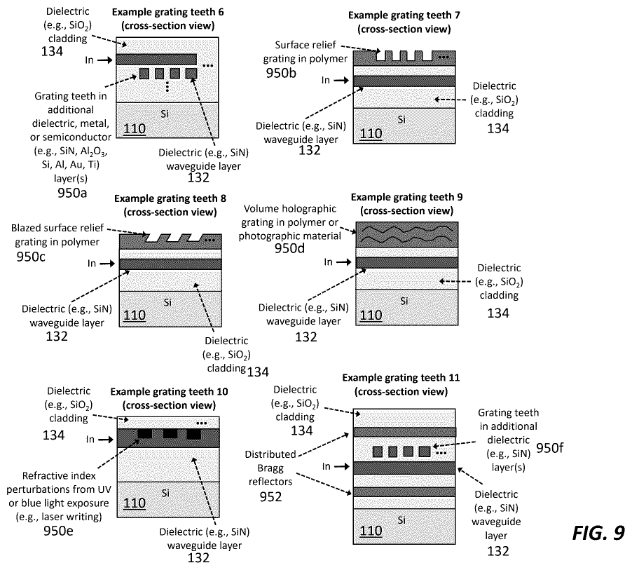

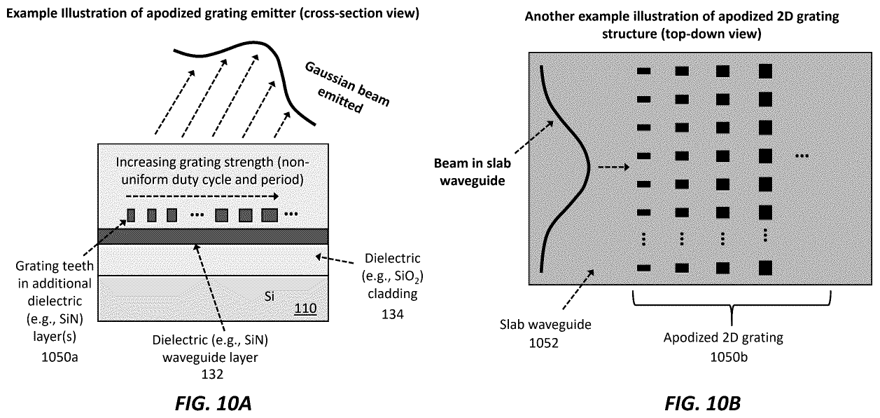

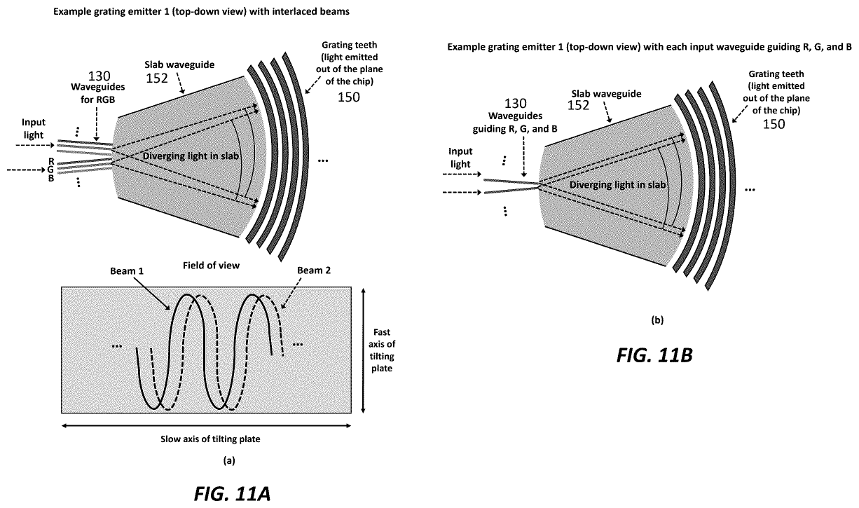

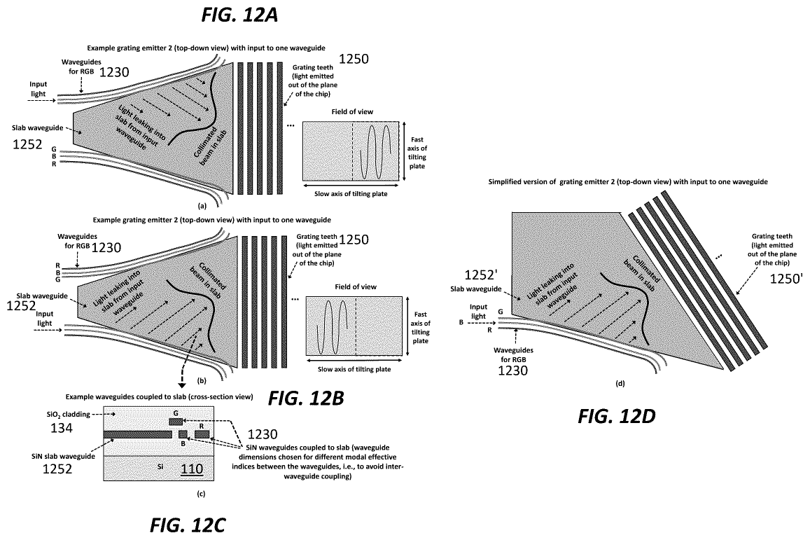

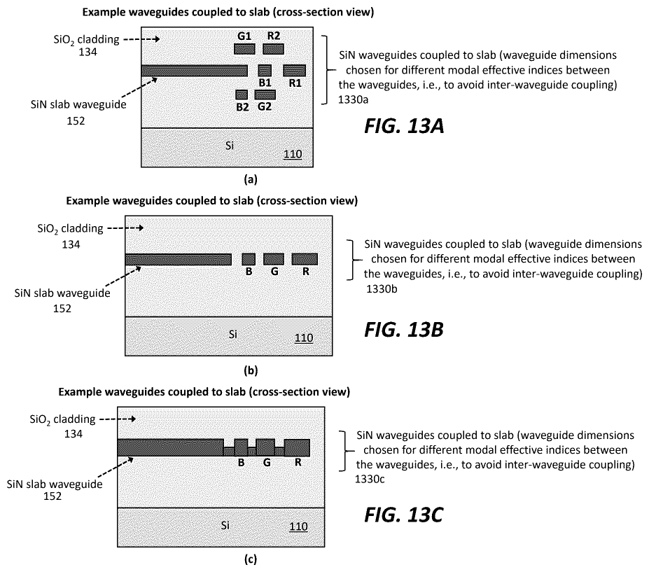

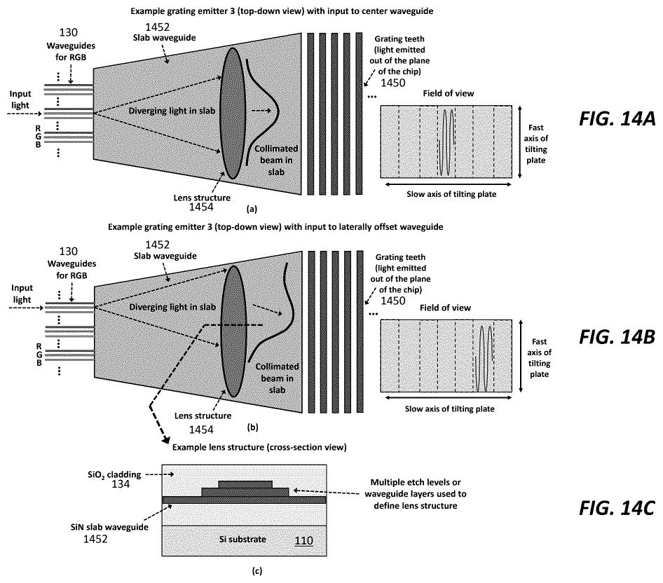

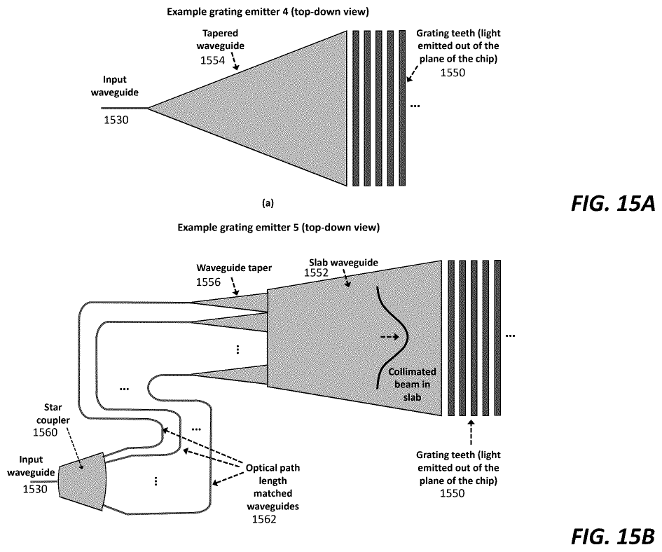

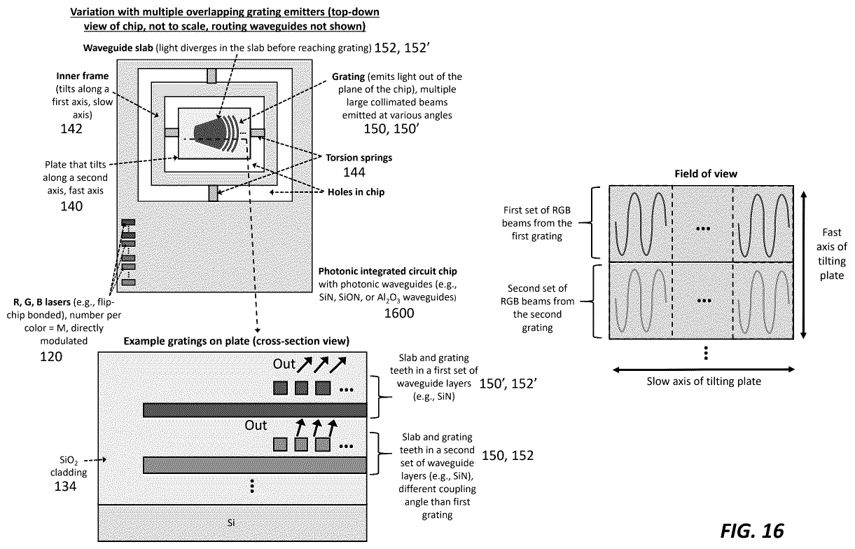

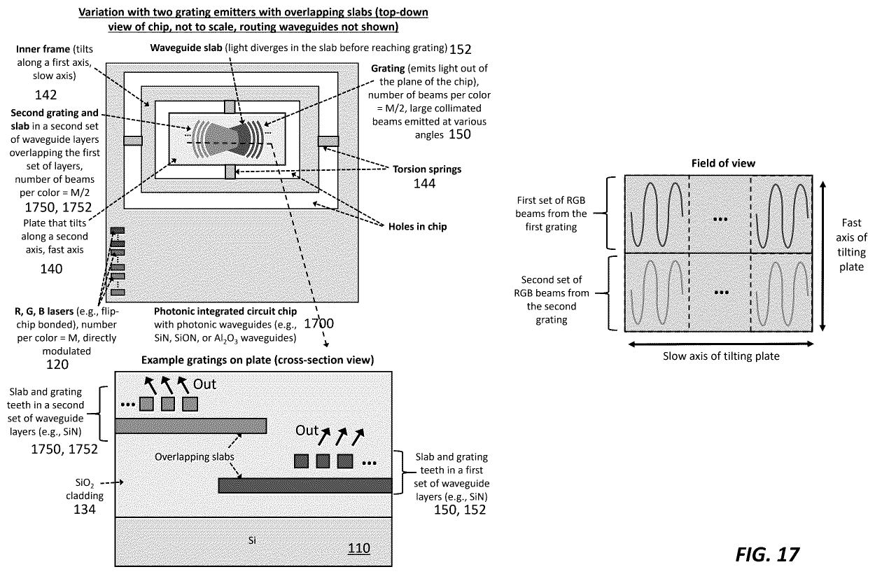

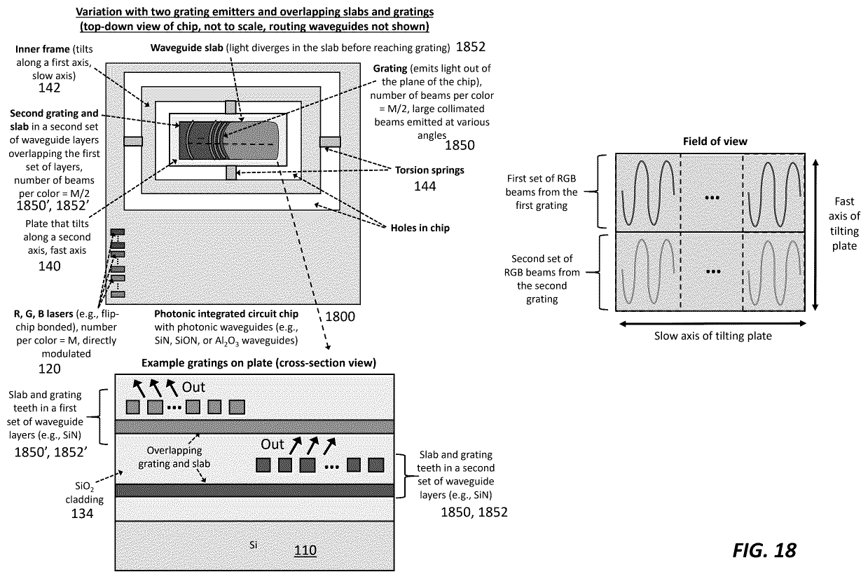

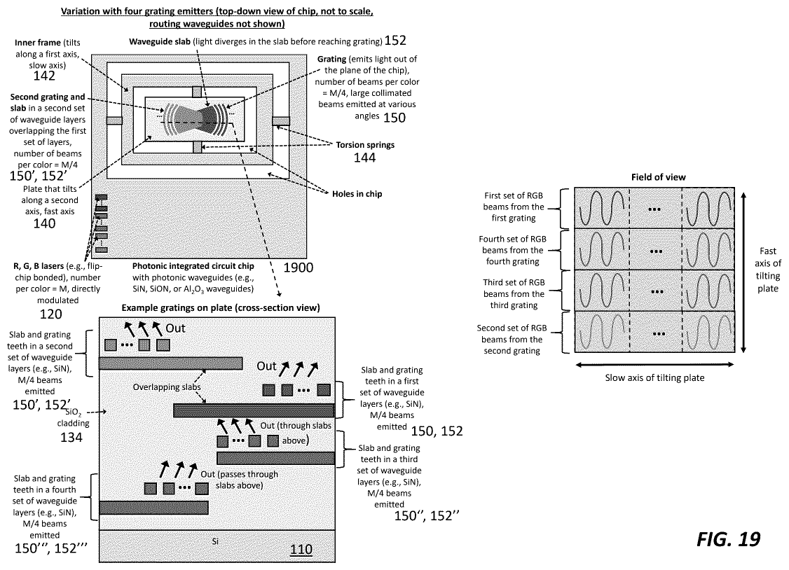

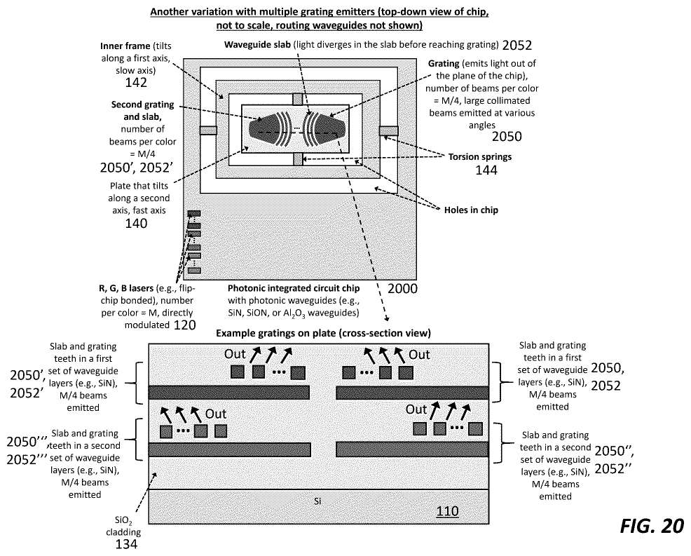

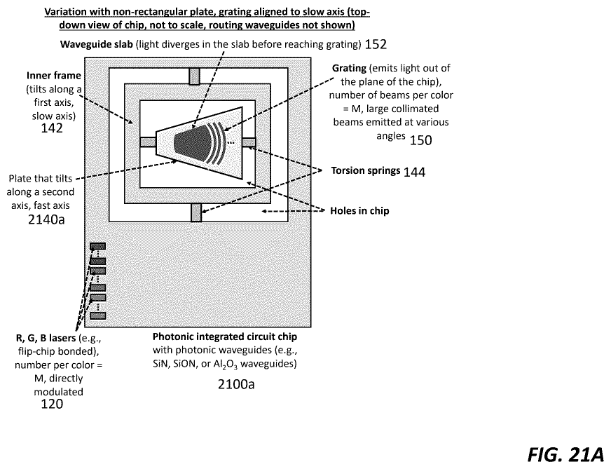

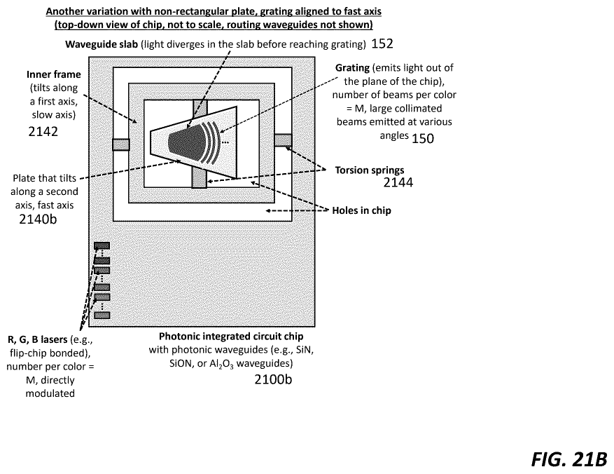

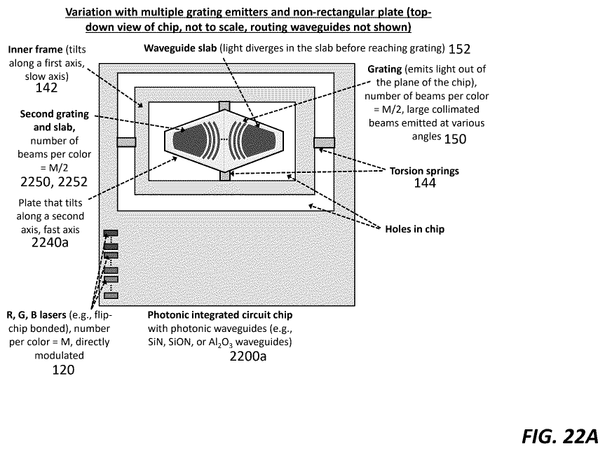

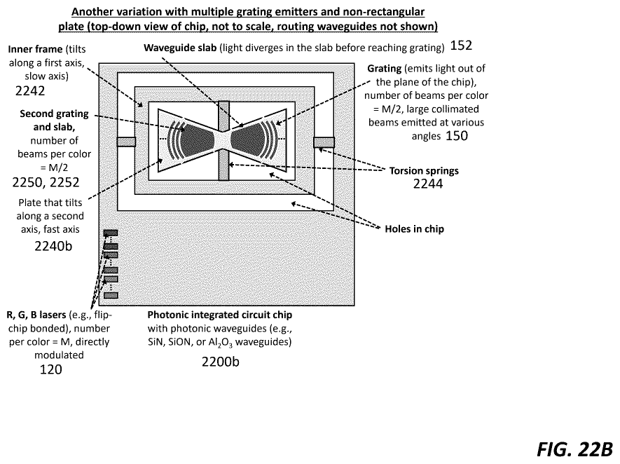

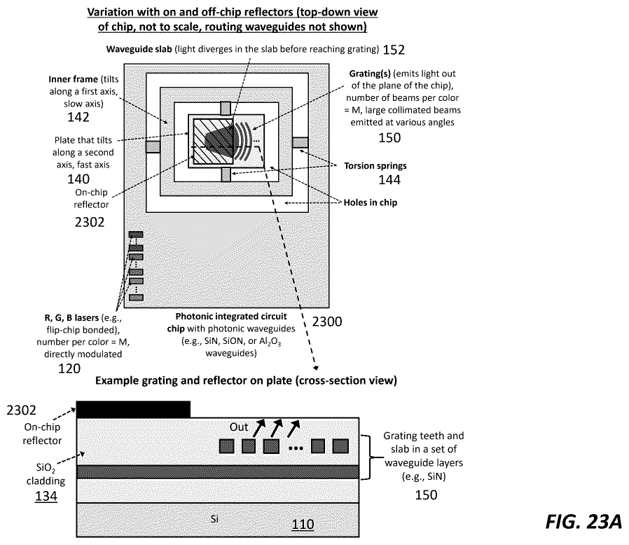

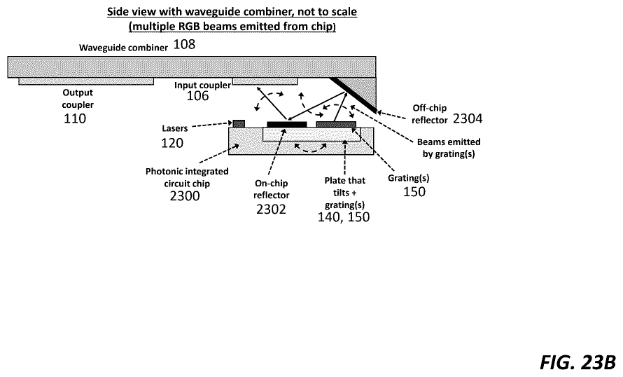

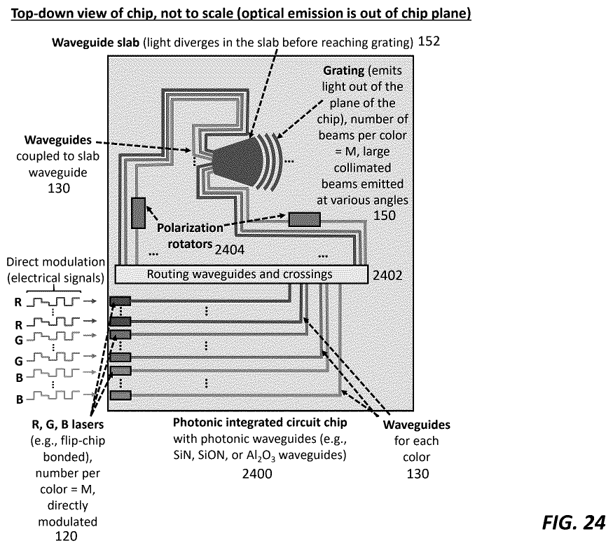

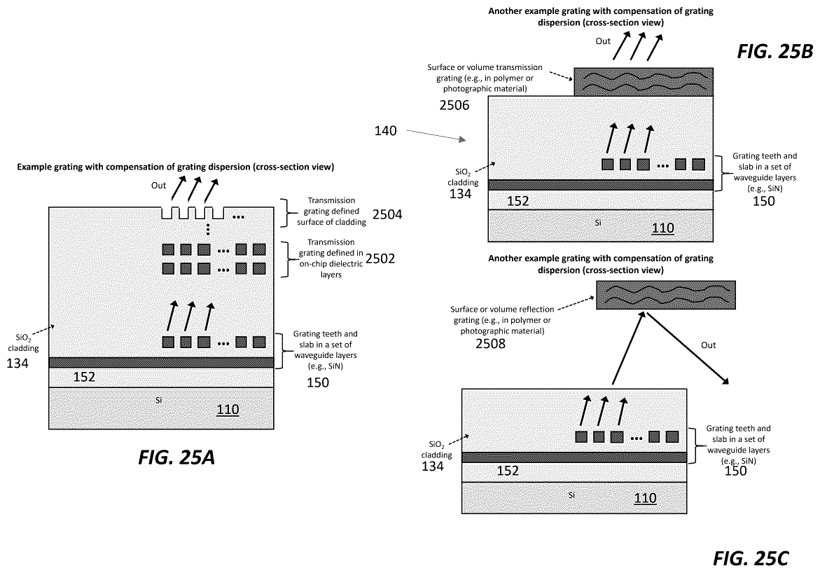

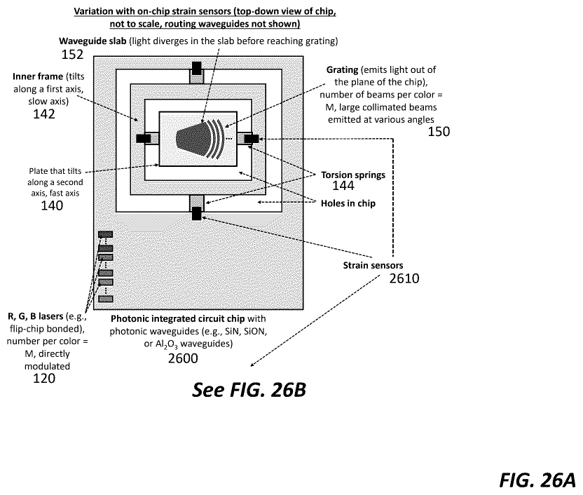

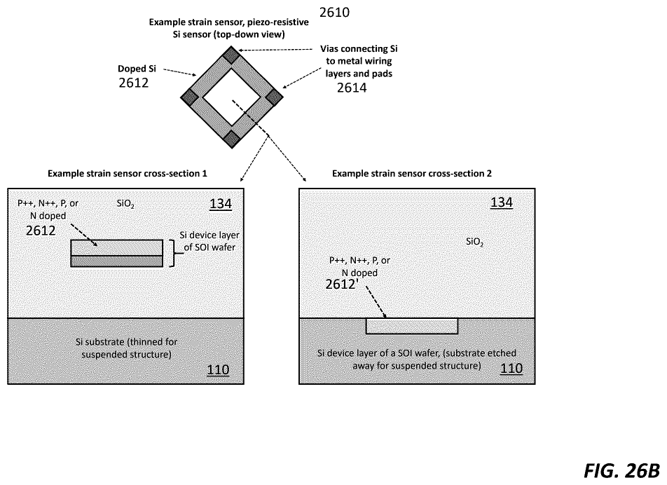

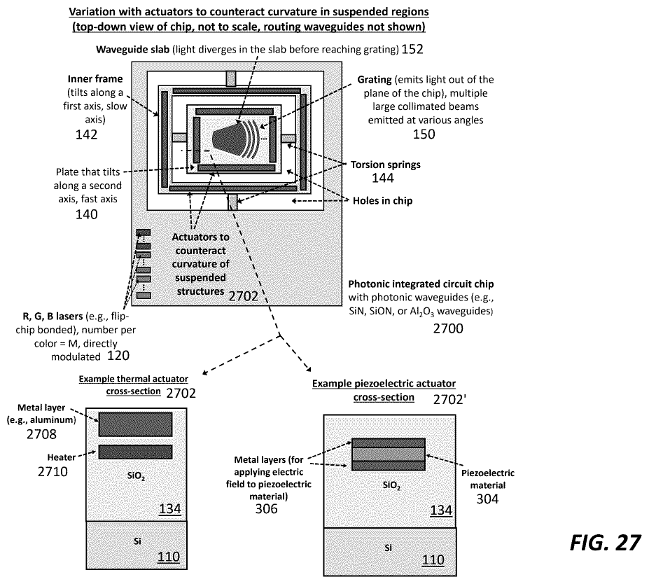

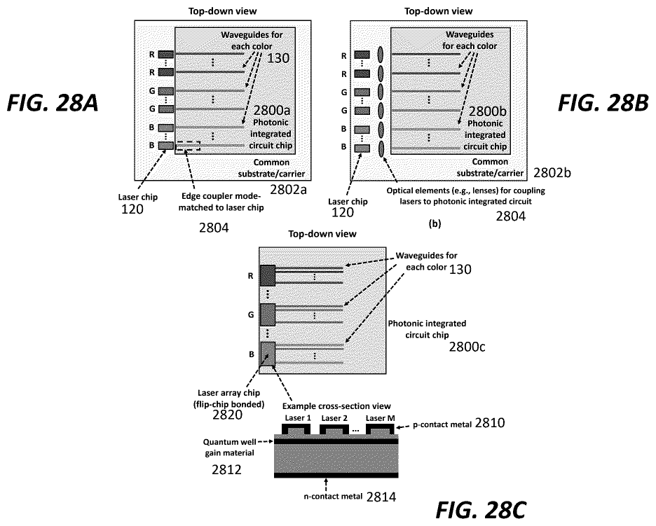

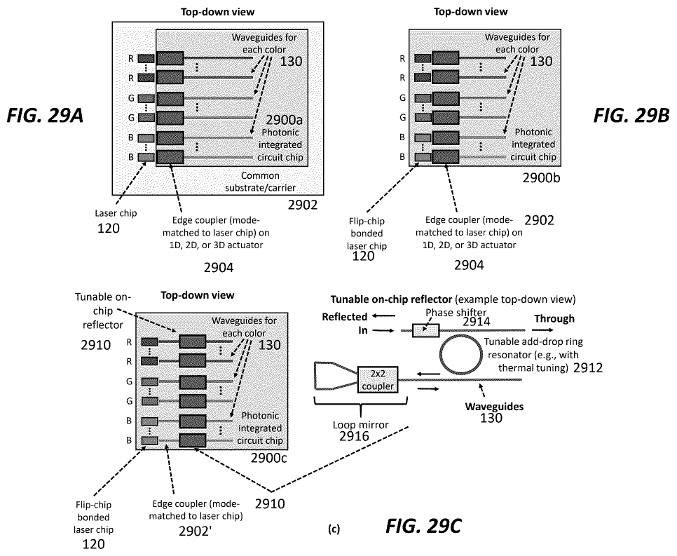

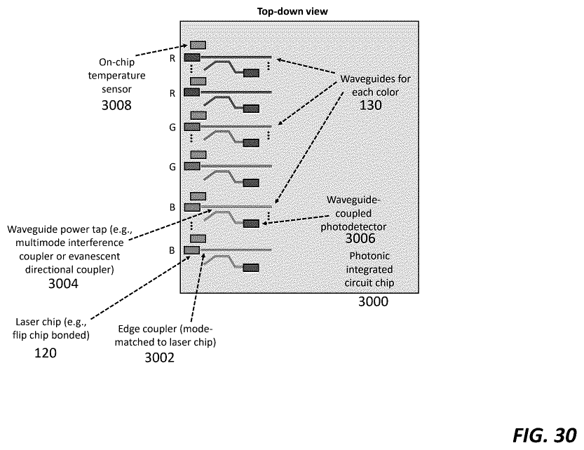

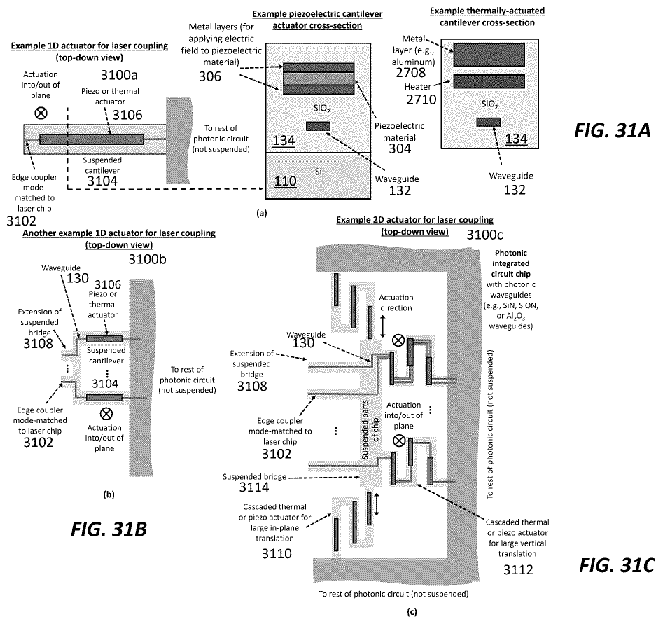

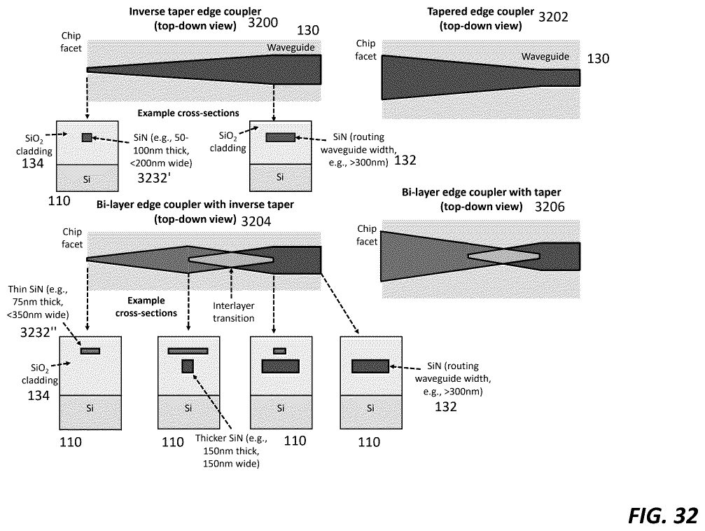

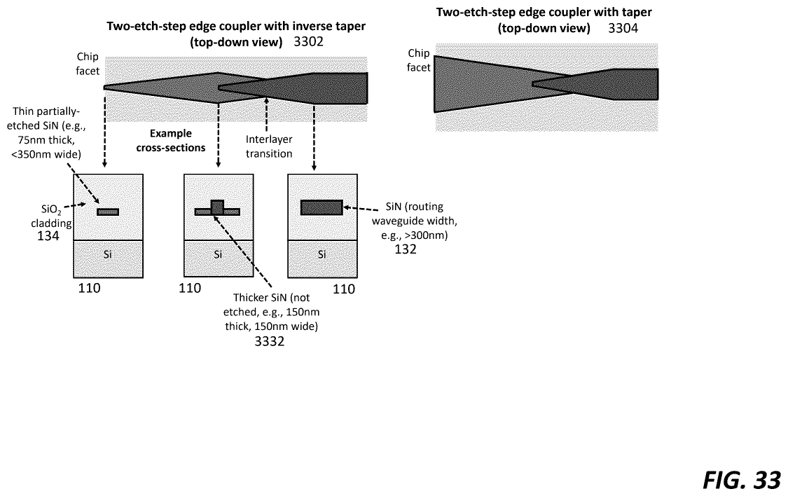

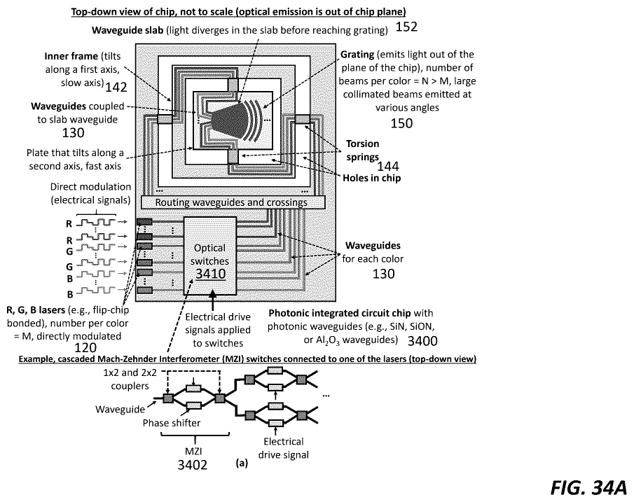

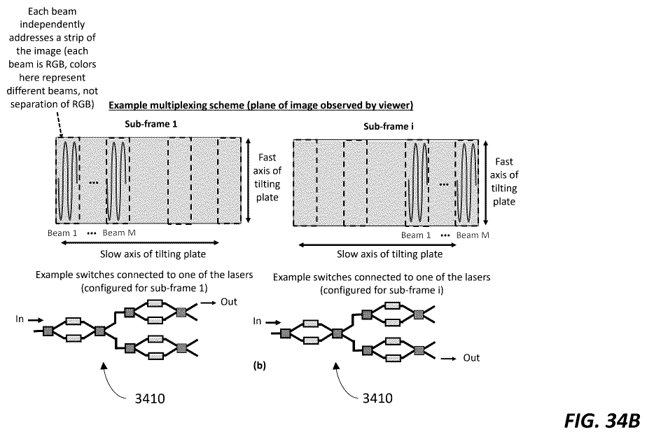

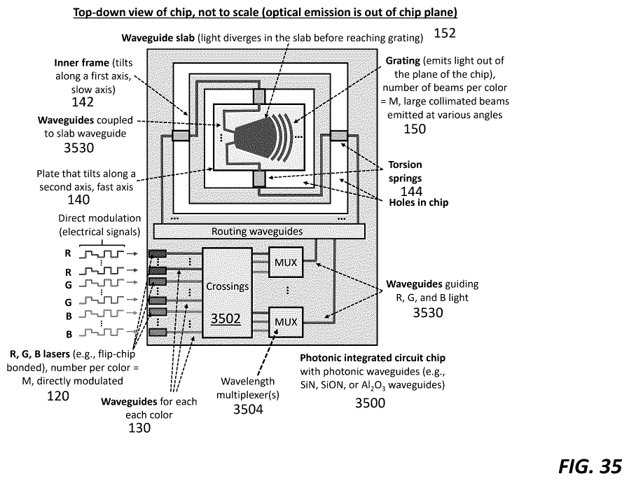

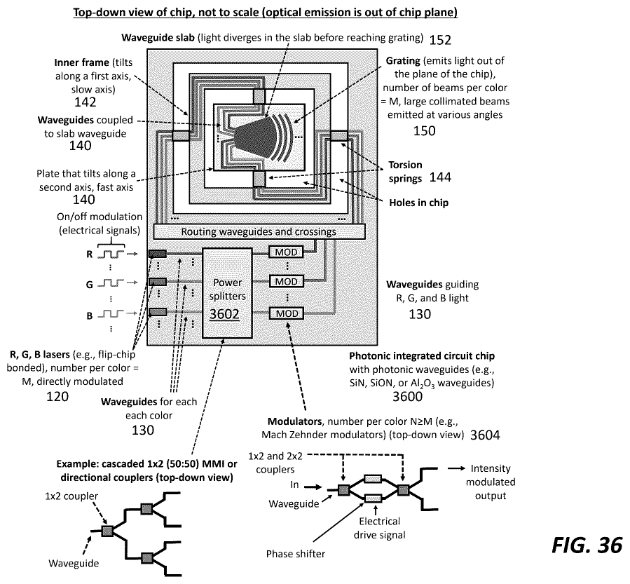

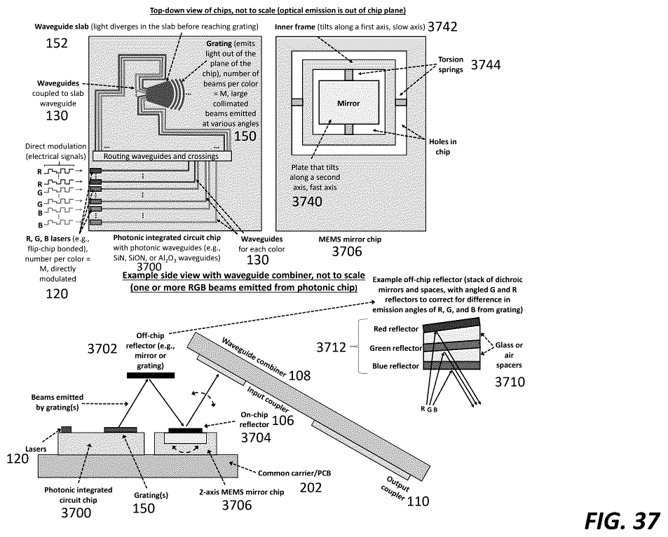

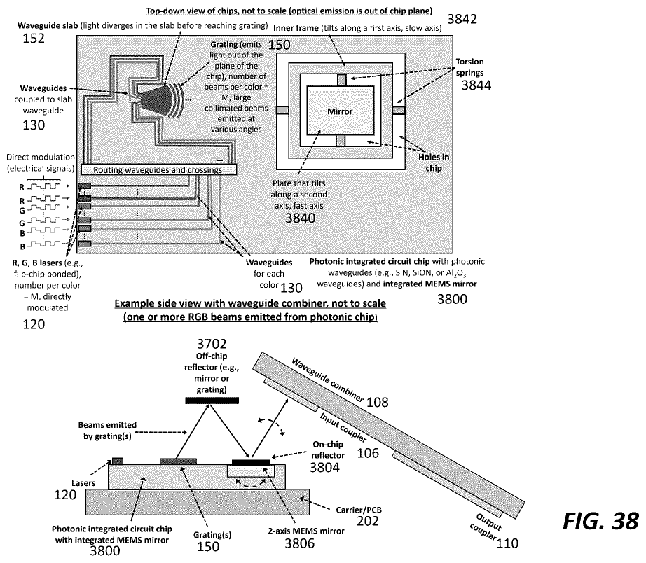

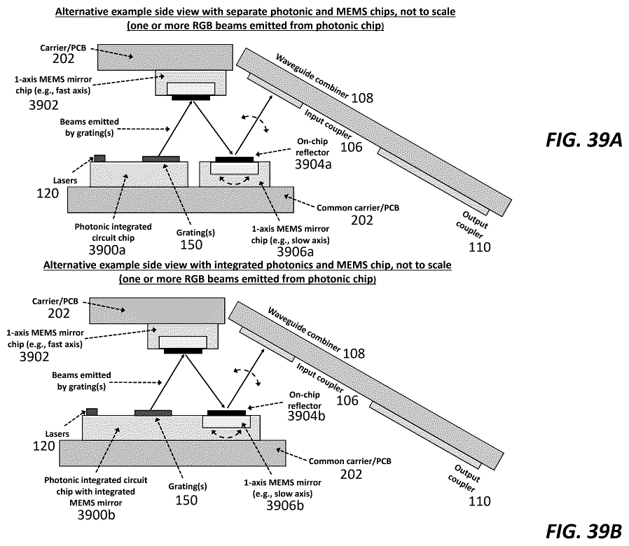

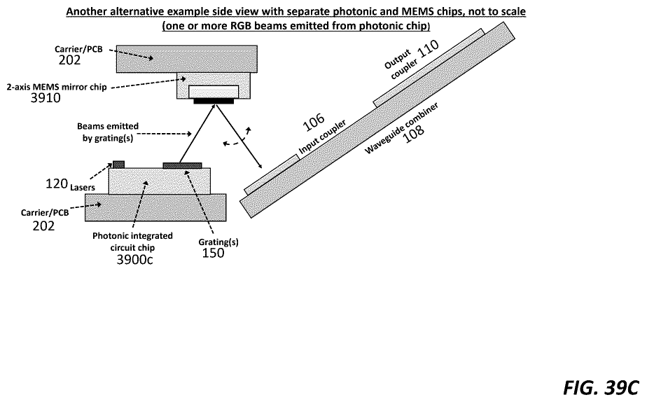

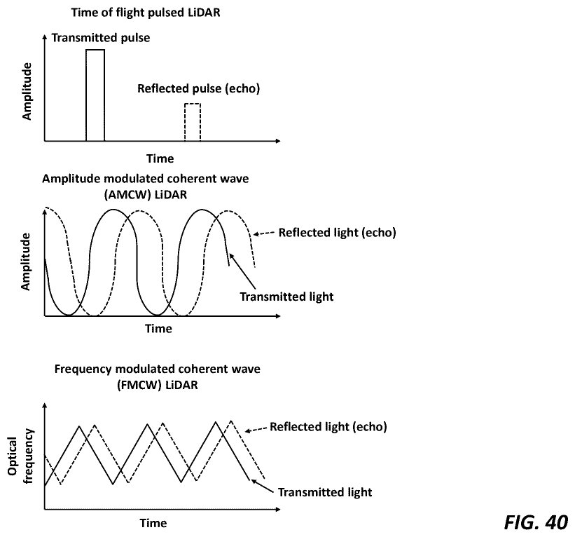

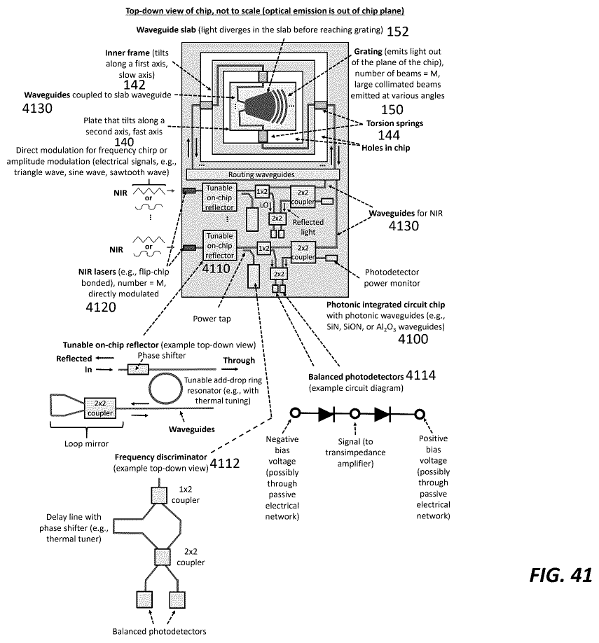

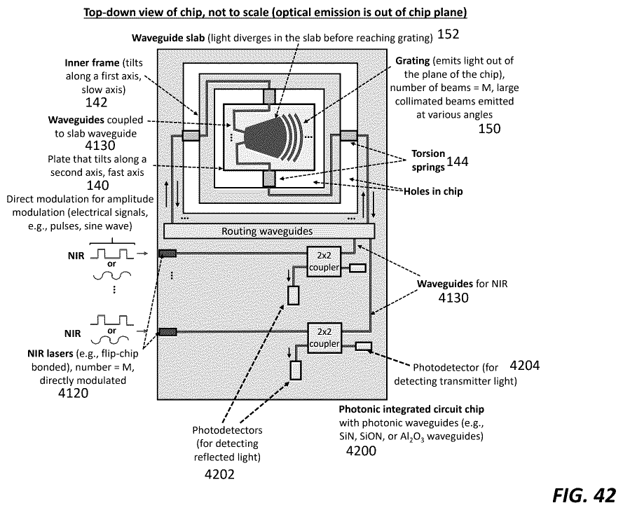

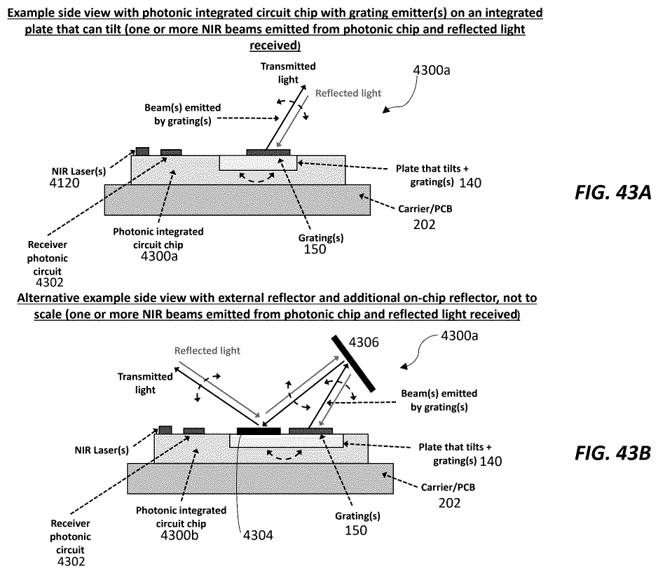

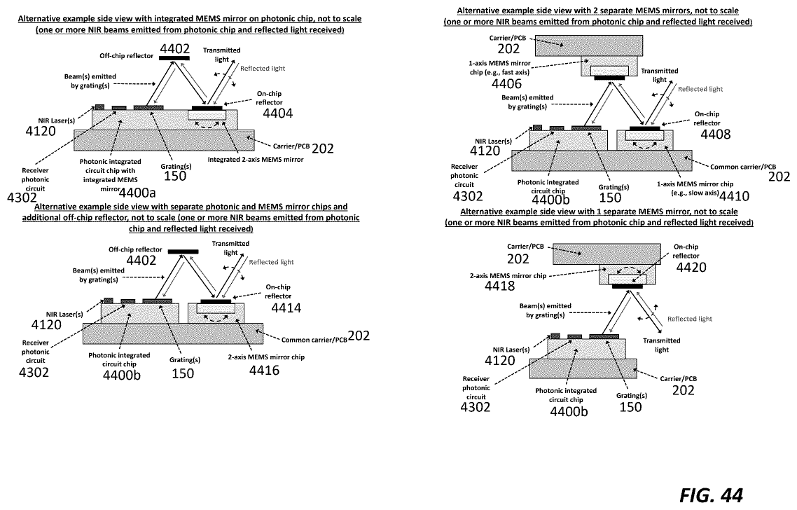

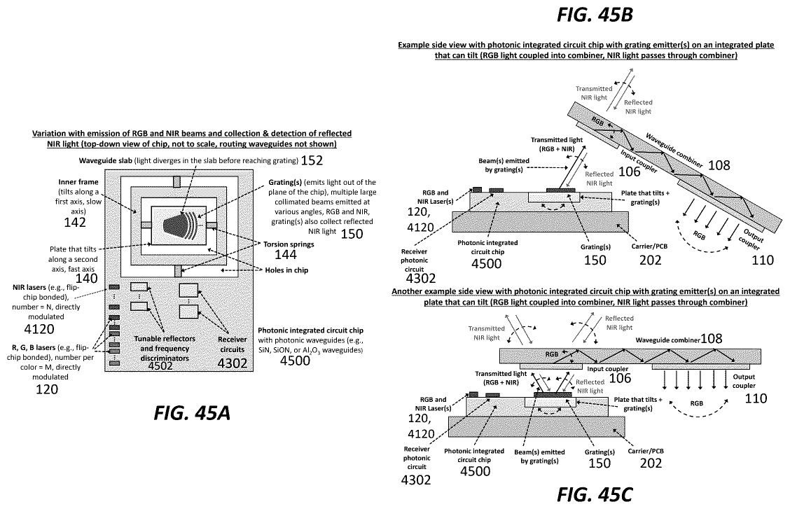

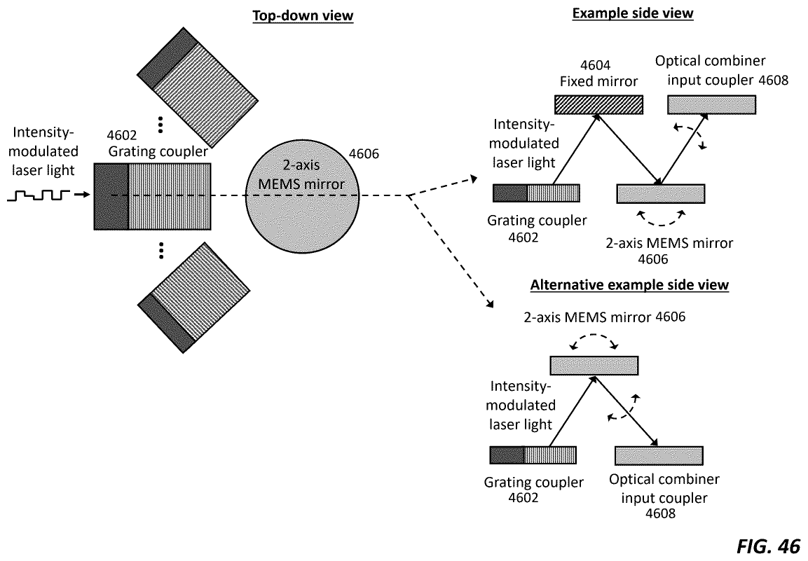

FIG. 1B illustrates the photonic integrated circuit chip used as a light engine. The chip is placed in close proximity to the input coupler of an optical combiner (here a waveguide combiner), and the multiple steered beams from the chip are coupled into the combiner, guided via total internal reflection, replicated (via pupil replication elements), and out-coupled toward the eye of the viewer by the output coupler.

FIG. 1C shows how the photonic chip addresses the FOV of the viewer in slices, each corresponding to an independent, intensity-modulated, steered RGB beam from the photonic chip. Small offsets in the beam angle along the fast axis (with 0 plate deflection) are possible due to the dependence of the grating diffraction angle on the propagation angle in the slab. Offsets between R, G, and B beams within each slice may also occur due to wavelength dependence in the grating diffraction angle and small differences in the slab propagation angle for R, G, and B waveguides within a subset, and in the inset, the effect is exaggerated. These offsets can be compensated for digitally (i.e., by adjustment of the input image data to the light engine).

FIG. 2A shows a photonic integrated circuit chip with a movable plate based on electromagnetic actuation using a coil. The coil is formed from on-chip metal wires and is defined on the inner frame of a movable plate with a gimbaled design. An applied magnetic field is oriented in the chip plane but diagonal to the principal axes of the inner frame. Oscillating electrical current passed through the coil can cause 2D rotation of the movable plate via the Lorentz force. A slow or quasi-static oscillation of the current rotates the inner frame (slow axis), and a higher frequency oscillation matching the fast axis resonance frequency rotates the movable plate. Combining both the slow and fast frequency components into the electrical drive signal results in periodic 2D scanning.

FIG. 2B shows how the magnetic field may be applied by permanent magnets positioned around the photonic chip on a common substrate/carrier (e.g., printed circuit board (PCB)) with the photonic chip.

FIG. 3A shows a photonic integrated circuit chip with a movable plate and external piezoelectric actuators. The piezoelectric actuators may be formed from a piezoelectric material with electrodes for applying an electric field to the material. Electrical signals applied to the piezoelectric actuators cause vibrations that can couple to mechanical resonances of the fast and slow axes of the movable plate (e.g., for a Lissajous scan pattern).

FIG. 3B shows a photonic chip with piezoelectric actuators attached to a common carrier/substrate on which the photonic chip is also attached.

FIG. 3C shows a photonic chip attached on top of piezoelectric actuators.

FIG. 4 shows a photonic integrated circuit chip with a movable plate and on-chip piezoelectric actuators. The actuators are formed from a piezoelectric material and electrodes deposited on the chip. Similar to FIGS. 3A-3C, electrical signals applied to the actuators lead to vibrations that can excite the slow- and fast-axis mechanical resonances.

FIG. 5 shows another example of a photonic integrated circuit chip with a movable plate and on-chip piezoelectric actuators. This is a gimbal-less design. Suspended cantilevers with embedded piezoelectric actuators connect to the movable plate via on-chip springs. Electrical signals applied to the actuators modulate the stress in the piezoelectric material, bending the cantilevers. Opposing drive signals applied to different sets of cantilever actuators enables tilting of the platform. Both axes may be operated in resonant or quasi-static mode.

FIG. 6 shows yet another example of a photonic integrated circuit with a movable plate and on-chip piezoelectric actuators. This is a gimbal-less design. Meandering suspended cantilevers with piezoelectric actuators connect to the movable plate. Electrical signals applied to the actuators cause bending of the cantilevers (similar to FIG. 5), but in this case, by cascading multiple cantilevers (meandering design), the upward/downward motions of each cantilever add up.

FIG. 7A shows a photonic integrated circuit chip with movable plates and on-chip piezoelectric actuators as in FIG. 5, but with a gimbaled design. The fast axis operates on resonance, and the drive signals have a frequency component aligned to the fast axis resonance frequency.

FIG. 7B shows a photonic chip corresponding to FIG. 6, but with a gimbaled design. Again, the fast axis operates on resonance, and the drive signals have a frequency component aligned to the fast axis resonance frequency.

FIG. 8A shows a top-down illustration of a grating with a waveguide slab and curved grating teeth. An on-axis subset of RGB waveguides couples light into the slab. Light diverges in the slab to a large (possibly millimeter-scale) width and is coupled out of the chip by a grating with curved teeth (the teeth curvature designed to match the phase front of the diverging on-axis beam in the slab and emit a collimated or low divergence beam, e.g., using elliptical grating teeth). This RGB beam addresses a slice of the FOV when scanned by the moving plate.

FIG. 8B is a top-down illustration of the grating with an off-axis subset of waveguides coupling light into the slab; the light propagates at an angle in the slab, with a corresponding shift in the angle of the emitted beam relative to the on-axis beam. The closely spaced subsets of waveguides form RGB beams.

FIG. 8C shows cross sections of different grating teeth designs. Grating teeth may be fully etched, partially etched, formed from grating teeth in one or more waveguide layers above the slab waveguide layer (these additional layer(s) being formed from the same material or different material(s) as the slab), may include a reflector underneath the grating (e.g., a metal reflector or a distributed Bragg reflector), and/or include grating teeth defined by etching the top surface of the cladding of the slab.

FIG. 9 shows additional grating cross-section possibilities. The grating teeth may be formed in one or more waveguide layers below the slab waveguide layer (these additional layers using the same or different materials as the slab waveguide layer). Alternatively, the grating teeth may be formed in a polymer material on the top surface of the chip and close to the slab waveguide layer (e.g., surface relief gratings, possibly blazed). Additionally, a volume holographic grating may be defined on top of the slab waveguide layer, for example, in a polymer or photographic material. Also, the grating teeth may be laser written in the slab waveguide layer (possibly using ultraviolet light); the laser locally modifying the refractive index of the slab and defining perturbations. The grating teeth can also be formed in a layer parallel to the slab waveguide and situated between a pair of distributed Bragg reflectors.

FIG. 10A shows a cross section of an apodized grating. The duty cycle and length of each period in the apodized grating are designed such that: (1) the grating strength increases along the grating with a suitable profile to form a Gaussian beam, and (2) constructive interference occurs between the emissions from all grating periods at the desired diffraction angle (reducing the beam divergence).

FIG. 10B shows a top-down illustration of an apodized grating using 2D grating teeth features. Each period of the 2D apodized grating includes a number of patterned features along the transverse axis of the beam in the slab (e.g., using the grating teeth designs in FIGS. 8A-8C and 9). The period in the transverse direction is made sufficiently small to avoid coupling light to higher order optical modes of the slab. 2D gratings enable weak grating strengths to be achieved with larger feature sizes since the duty cycle along the transverse direction can be adjusted to weaken the grating.

FIG. 11A illustrates a variation of the grating with a slab and curved teeth for interlaced beams. Closely spaced subsets of waveguides coupling light into the slab may have a relatively small angular offset between one another (corresponding to one or a small number of lines in the FOV). The FOV may be addressed by a number of interlaced beams, or alternatively, by a number of sets of interlaced beams, each addressing a slice of the FOV.

FIG. 11B is a top-down illustration of the variation of the grating with slab and curved grating teeth with each input waveguide to the slab simultaneously guiding R, G, and B light. This may be accomplished using wavelength multiplexer devices in the photonic integrated circuit (multiplexing light from a set of R, G, and B lasers onto a single waveguide), as in FIG. 35.

FIG. 12A shows a top-down illustration of an alternative slab and grating based on evanescent coupling/leakage of light from waveguides into the slab. If the slab has a higher effective index than the waveguide modes, light from the waveguides leaks into the slab, with the angle of propagation in the slab determined by a phase matching condition. Waveguides are routed toward the slab and curve along an edge of the slab, with the gap between the slab and waveguide determining the coupling strength. The shape of the gap vs. length curve is used to apodize the coupling and form a Gaussian beam in the slab. Multiple waveguides are coupled to the slab and multiple beams are formed in the slab.

FIG. 12B shows another view of the alternative slab and grating of FIG. 12A with light input to a different set of waveguides.

FIG. 12C shows a cross-section of the slab and grating of FIG. 12A, with three waveguides guiding R, G, and B light coupled to the slab. The waveguide widths and/or thicknesses are mismatched to avoid coupling between the waveguides (i.e., the effective indices of optical modes in the three waveguides at R, G, and B wavelengths are different). A subset of RGB waveguides may be coupled to a first facet of the slab, and another subset of RGB waveguides may be coupled to a second facet of the slab. Each subset of waveguides emits an RGB beam into the slab at an angle relative to the grating teeth as shown in FIGS. 12A and 12B and the resultant two beams emitted from the grating are angled with respect to one another.

FIG. 12D is a top-down illustration of a simplified slab and grating design with waveguides coupled to a single facet of the slab and the grating teeth angled and aligned to the propagation axis of the beam in the slab. The grating teeth used in this design may be any of those shown in FIGS. 8-10.

FIG. 13A shows waveguides in multiple layers above, in plane, and below the slab and evanescently coupled to the slab, enable two or more RGB beams to be coupled at a single slab facet. The first subset of waveguides (R1,G1,B1) may have widths and thicknesses designed to couple into the slab at a different angle than the second subset of waveguides (R2,G2,B2), and all waveguides may be designed to have different fundamental mode effective indices at R, G, and B wavelengths (to avoid inter-waveguide coupling).

FIG. 13B shows three waveguides in the same layer as the slab and that can be coupled to the slab.

FIG. 13C shows a partially-etched region defined in the gaps between waveguides and slab in FIG. 13B to increase the coupling strength from the waveguides to the slab (potentially enabling larger gaps for a given beam diameter).

FIG. 14A shows a grating and slab with a lens structure defined in the slab. Light diverging from waveguides coupled to the slab is collimated by the lens structure and then emitted by the grating. The lateral position of the waveguide along the slab input is mapped to angle of the collimated beam in the slab. Multiple beams at various angles may be emitted from the grating.

FIG. 14B shows another view of the grating and slab of FIG. 14A with light input to a different set of waveguides.

FIG. 14C The lens structure may be formed from multiple partial etch steps in the waveguide layer.

FIG. 15A shows a grating design using a tapered waveguide. The taper shape may be nonlinear to reduce the taper length while maintaining high transmission.

FIG. 15B is a top-down illustration of a grating emitter using a zero-order arrayed waveguide grating.

FIG. 16 shows a photonic chip with overlapping gratings and slab waveguides on a movable plate to enable FOV splitting along a second direction (here, the fast axis).

FIG. 17 shows a photonic chip with gratings and slabs in separate layers on a movable plate, with the gratings face away from one another to enable FOV splitting along a second direction.

FIG. 18 shows a photonic chip with a movable plate that includes a slab in an upper waveguide layer overlapping a grating in a lower set of waveguide layers.

FIG. 19 shows a photonic chip with four gratings and slabs in four separate layers on a movable plate.

FIG. 20 shows a photonic chip with two sets of opposing slabs and gratings in two layers on a movable plate.

FIGS. 21A and 21B show photonic integrated circuit chips with non-rectangular movable plates.

FIGS. 22A and 22B show photonic integrated circuit chips with non-rectangular movable plates and multiple slabs and gratings.

FIG. 23A shows top and cross-sectional views of a photonic integrated circuit chip with on- and off-chip reflectors. Steered beams emitted from gratings on the movable plate are reflected toward a reflector defined on the movable plate and then reflected into the input coupler of an optical combiner (e.g., waveguide combiner). The on-chip reflector may be a metal mirror and may be defined over the waveguide slab(s) on the movable plate. The optical beam deflection is three times the mechanical deflection of the plate.

FIG. 23B shows a side view of the photonic integrated circuit chip of FIG. 23A in combination with a waveguide combiner.

FIG. 24 shows a photonic integrated circuit with polarization rotators to convert a transverse-electric (TE) polarization in the waveguides to a transverse-magnetic (TM) polarization. Polarization rotators may be added onto waveguides corresponding to one or more wavelengths (e.g., here, on blue waveguides).

FIG. 25A shows an on-chip transmission grating that compensates for grating dispersion (i.e., wavelength-dependent diffraction angle from the grating). The on-chip transmission grating is formed above the grating emitter from one or more patterned dielectric layers and/or grating features etched into the top surface of the cladding.

FIG. 25B shows a surface or volume transmission grating defined in a polymer or photographic material may be attached to the surface of the cladding above the grating.

FIG. 25C shows a surface or volume reflection grating (e.g., in metals, semiconductors, dielectrics, polymers, or photographic materials) that is aligned above the chip, and the steered beams emitted by the chip reflect off the reflection grating.

FIG. 26A shows strain sensors integrated onto the photonic integrated circuit chip (to monitor the deflection of the movable plate). The strain sensors may be positioned near attachment points of torsion springs.

FIG. 26B shows the strain sensors, which may be piezoresistive sensors formed from the doped Si device layer of a silicon-on-insulator (SOI) wafer (either etched into wires or with wires defined by doping). The doped Si wires are arranged in a Wheatstone bridge configuration, which is common for strain sensors on MEMS mirrors.

FIG. 27 shows a variation including actuators on the inner frame and movable plate that apply stress that can compensate for curvature of these parts due to the stresses of the thin films deposited on them (i.e., the waveguide and cladding layers).

FIG. 28A shows laser chips aligned to edge couplers on a photonic chip, with the laser chips and photonic chip attached to a common substrate/carrier. The chips may be attached to the substrate face-up or flip-chip bonded.

FIG. 28B shows laser chips coupled to edge couplers through small optics (e.g., lenses) that are also attached to the common substrate/carrier.

FIG. 28C shows laser array chips used with a photonic chip. A set of individual lasers (with a lithographically defined pitch) may alleviate packaging challenges associated with aligning many laser chips to the photonic integrated circuit chip. In butt-coupling approaches, (e.g., as in FIGS. 28A and 28C) and flip-chip bonding (e.g., as in FIG. 1A), the optical modes at the tips of the edge couplers on the photonic chip should be closely matched to the transverse optical modes of the lasers (for efficient coupling).

FIG. 29A shows actuators on a photonic chip used to move the edge couplers in 1D, 2D, or 3D for optimizing the alignment of the edge couplers to the laser chips on a common substrate/carrier with the photonic chip.

FIG. 29B shows lasers flip-chip bonded to a photonic chip with actuators to move the edge couplers for aligning the edge couplers to the laser chips.

FIG. 29C illustrates an example where tunable waveguide reflectors on a photonic chip are used to reflect light with tuned amplitude, phase, and/or spectrum back into the laser chips (feedback). The tunable on-chip reflectors may include add-drop ring resonators and loop mirrors.

FIG. 30 illustrates a photonic integrated circuit chip (region near the lasers) with on-chip waveguide-coupled photodetectors (to monitor laser powers) and on-chip temperature sensors (to monitor laser temperatures). The temperature sensors may be formed from thin film metallic wires or doped Si wires; resistance changes with temperature. Power taps (e.g., evanescent directional couplers or multimode interference couplers) couple a small fraction of light from each waveguide to a separate waveguide-coupled photodetector.

FIG. 31A illustrates a 1D suspended cantilever actuator with one or more embedded edge coupler(s) for aligning the edge couplers to lasers in a photonic integrated circuit chip.

FIG. 31B shows multiple 1D cantilever actuators connected to a bridge containing the edge couplers in a photonic integrated circuit chip.

FIG. 31C shows a 2D actuator (up/down and in-plane/out-of-plane in the illustration) based on cascaded cantilever actuators suitable for use in a photonic integrated circuit chip.

FIG. 32 shows top-down and cross-section views of tapered, inverse tapered, single layer, and bi-layer edge couplers suitable for use in inventive photonic chips.

FIG. 33 shows edge couplers made with a two-step etch suitable for use in inventive photonic chips.

FIG. 34A illustrates a photonic integrated circuit chip with optical switches, shown as cascaded 1×2 Mach Zehnder interferometer (MZI) switches, connected to each laser.

FIG. 34B illustrates a multiplexing scheme for the photonic chip of FIG. 34A.

FIG. 35 shows a photonic integrated circuit chip with wavelength multiplexer devices used to multiplex a R, G, and B signal onto each waveguide coupled to a slab; each waveguide then emits an RGB beam into the slab with R, G, and B co-axial.

FIG. 36 shows a photonic integrated circuit chip where on-chip high-speed optical modulators apply the intensity modulation required to define the brightness of each pixel (instead of direct modulation of the lasers). Here, light from each laser is split into multiple waveguides using on-chip splitter devices; each of these waveguides connects to an on-chip optical intensity modulator followed by routing waveguides connected to the slab(s) and grating(s) for emitting the light. As an example, the optical modulators may be MZI modulators using high-speed phase shifters.

FIG. 37 illustrates an optical system with a photonic chip and an external MEMS mirror (and no movable plate on the photonic chip).

FIG. 38 illustrates a system and photonic integrated circuit chip with a 2-axis MEMS mirror integrated onto the photonic integrated circuit chip.

FIG. 39A shows an optical system with two 1-axis MEMS mirror chips used to scan the light emitted from the grating(s).

FIG. 39B shows an optical system with an external 1-axis MEMS mirror chip and an integrated 1-axis MEMS mirror used to scan the light emitted by the grating(s).

FIG. 39C shows an optical system with an external 2-axis MEMS mirror chip positioned above the photonic chip (and on a different carrier/PCB) and used to scan the light emitted by the grating(s).

FIG. 40 illustrates transmitted and reflected optical signals for (top) time-of-flight pulsed LiDAR, (middle) amplitude modulated coherent wave (AMCW) LiDAR, and (bottom) frequency modulated coherent wave (FMCW) LiDAR.

FIG. 41 shows a photonic integrated circuit chip for FWCW or AMCW LiDAR with coherent detection.

FIG. 42 shows an alternative photonic integrated circuit chip for LiDAR. The reflected light is separated by the 2×2 couplers and directly detected by on-chip photodetectors (no coherent detection). This variation is compatible with AMCW LiDAR where extraction of the phase of the amplitude modulation of the reflected light is performed in the electronic domain. This variation is also compatible with pulsed time-of-flight LiDAR, where the arrival time of the reflected pulse is measured.

FIG. 43A illustrates a photonic integrated circuit chip being used for LiDAR, with NIR beams emitted by the grating(s) on the movable plate scanned across a scene by the movable plate.

FIG. 43B shows a LiDAR system with an off-chip reflector and a reflector integrated onto the movable plate (e.g., a metal mirror above the waveguide slab region of the plate).

FIG. 44 illustrates alternative LiDAR systems.

FIG. 45A shows a photonic integrated circuit chip for simultaneous light engine and LiDAR functionalities.

FIGS. 45B and 45C show the photonic chip of FIG. 45A positioned close to the input coupler of an optical combiner.

FIG. 46 shows a photonic integrated circuit chip and system configuration with gratings and slabs arranged along a curve on the photonic chip.

### DETAILED DESCRIPTION

Laser-scanning optical systems based on photonic integrated circuits can generate multiple modulated, large-diameter, collimated (or low-divergence) steerable beams. Multi-beam scanning has advantages for light engines (the miniature displays in augmented reality glasses) and LiDAR systems compared to systems that scan a single beam. Specifically, scanning the field of view (FOV) by multiple beams in parallel results in faster, higher-resolution scanning that overcomes limitations of conventional single-beam laser scanning systems based on microelectromechanical systems (MEMS) mirrors, where the fast axis frequency of the MEMS mirror fundamentally limits the resolution for a given FOV. Unlike other systems, the laser-scanning optical systems here use photonic integrated circuit chips, also called photonic chips, that emit collimated (or nearly collimated) beams without collimation lenses. Such lens-free, chip-based laser-scanning systems may be much smaller and lighter and have lower packaging complexity compared to laser-scanning optical systems with lenses. Applications of inventive laser-scanning optical systems include light engines for augmented reality glasses, LiDAR systems, and light engines for simultaneous display and LiDAR functionalities.

### Light Engines for Augmented Reality Glasses

FIGS. 1A-1C illustrate a laser-scanning optical system that includes lasers 120 packaged with a photonic integrated circuit chip 100 (possibly by flip-chip bonding) and coupled to on-chip optical waveguides 130. The waveguides 130 are coupled to a grating coupler emitter 150 (emitting light out of the chip plane) on a movable plate 140 that can be tilted along two angular axes (using on- or off-chip actuators) for steering of the emitted light. The waveguides 130 are coupled to the grating 150 via a slab waveguide 152 where the light is expanded in the plane of the chip 100. The light is subsequently radiated by the grating 150, which has a relatively low grating strength (expanding the light along a second axis)—enabling emission of beams with large diameters (possibly millimeter-scale) with low divergences, without collimation lenses. Coupling multiple waveguides 130 to the slab 152, each corresponding to a different propagation angle in the slab, results in multiple emitted beams from the grating 150 (each emitted with a different angle). Overall, the result is a set of large, collimated (or low divergence) beams at various angles emitted from the chip 100, which are continuously steered by rotation of the movable plate.

As shown in FIG. 1B, the chip 100 can be placed near the input coupler 106 of an optical combiner (e.g., waveguide combiner 108) to form a near-eye display system, with the photonic chip 100 functioning as a fully integrated light engine. In the waveguide combiner 108, the beams are coupled into the waveguide combiner 108, guided by total internal reflection (TIR), replicated by diffractive or reflective pupil replication elements, and out-coupled toward the eye 11 by an output coupler 110. Collimated (or low-divergence) beams input to the optical combiner 108 are expanded and output toward the eye 11 forming an image focused at infinity, whereby collimated (or low-divergence) beams with horizontal and vertical angles (θ, φ) are focused to position (x, y) on the user's retina. Since the images are focused at infinity, the display system is typically characterized by an angular field of view (FOV). The lasers 120 are intensity modulated to define the brightness of each pixel as the beams are rastered across the FOV of the viewer, with the FOV divided into slices addressed in parallel by the multiple beams.

The waveguides 130 of the photonic integrated circuits chip 100 may have silicon nitride (SiN) cores 132 with silicon dioxide (SiO₂) cladding 134, e.g., as shown in the accompanying figures. Other embodiments may use aluminum oxide (Al₂O₃), silicon oxynitride (SiON), doped silica, lithium niobate, or lithium tantalate waveguides with SiO₂ cladding. SiON may also be used as the cladding rather than SiO₂. Embodiments using polymer waveguides are also possible.

Grating couplers like the grating 150 are diffractive elements defined in a waveguide that can emit light out of the plane of the chip; they are often defined by etching grooves (“grating teeth”) into the waveguide (slab waveguide 152). Typically, grating couplers emit light at an angle relative to the normal of the chip (diffraction angle). The strength and dimension of each period may be engineered for radiation of a Gaussian beam (through a design method known as apodization). Furthermore, through apodization and design of the input beam width to the grating 150, the grating 150 may emit round beams with equal diameters and divergences along the two transverse axes.

In FIG. 1A, laser light is coupled to the waveguides of the photonic chip 100 from flip-chip-bonded lasers 120 via edge couplers 128, which are devices designed to achieve optical mode profiles (at their respective facets) that are well-matched to the transverse optical mode profile of the lasers (for efficient coupling). Each laser 120 is a diode laser mounted on a silicon substrate 110 or silicon device layer of a silicon-on-insulator (SOI) wafer 110 with solder bumps, metal wiring, and/or other mechanical stopper structures 126. Each laser 120 includes a laser waveguide core 122 with one end covered by a reflective coating 124 and the other (partially reflecting) end exposed to emit red, green, or blue light into free space. Each laser 120 is mated to a corresponding edge coupler 128, which couples the free-space emission into a corresponding waveguide 130.

The waveguides 130, each guiding red (R), green (G), or blue (B) light, are routed from the edge couplers to the slab waveguide 152, possibly crossing one another. The waveguides 130 are also routed along on-chip springs 144 connecting the movable plate 140 to the rest of the chip 100. The waveguides 130 may be arranged into subsets of three waveguides 130 (triplets), each with R, G, and B waveguides, and the intra-subset pitch may be sufficiently small such that the propagation angles of light in the slab coupled from the waveguides in each subset are nearly identical, effectively forming RGB beams in the slab from each subset. Various waveguide subsets may be coupled to the slab forming a set of independent beams in the slab with a variety of propagation angles. The routing waveguides 130 may cross each other in the photonic chip 100. These crossings may be implemented as in-plane multimode interference crossing devices, tapered waveguide crossings, or over/under-pass crossings using multiple waveguide layers.

The scan patterns of each beam may be offset from one another along a second axis (fast axis in FIGS. 1A-1C), which is due to beams propagating at different angles in the slab waveguide and propagating through the grating at an angle, potentially experiencing a different grating period than on-axis light. This effect may be reduced or eliminated through a curved grating design or may be compensated by emitting light from the lasers only when beams are directed to regions of the FOV slices that overlap a common range along the fast axis. Within each FOV slice, some offset between R, G, and B beams is expected along both axes; first, because of the intra-subset pitch leading to small slab propagation angle differences, and second, because the diffraction angle of light emitted from the grating is wavelength dependent. The offsets can be digitally compensated by adjusting the image data input to the display system, for example, by shifting the R, G, and B color components of the input images to align the color components of the final image observed by the viewer. The beams within each FOV slice may slightly overlap with their neighboring slices to avoid gaps in the FOV, the laser intensity may be adjusted in these overlapping regions for uniform brightness of the overall image, and the beams may form an interlaced pattern within these overlapping regions.

The movable plate 140 in FIG. 1A is one of multiple examples disclosed herein. Here, an “inner frame” 142 is connected to the rest of the photonic chip 100 by torsion springs 144 (structures mechanically compliant to twisting motion; in a simple example, a long beam that is thin and narrow). The movable plate 140 is connected to the inner frame 142 via two more torsion springs 144. The inner frame 142 (together with the movable plate 140) may rotate (tilt) along a first angular axis relative to the chip 100, and the movable plate 140 may rotate relative to the inner frame 142 along a second axis. This results in two-dimensional rotation of the movable plate 140 and the grating 150 integrated onto the movable plate 140. Such configurations are used in MEMS mirrors designs and are referred to as “gimbaled designs.”

The second axis (rotation of the movable plate 140 within the inner frame 142) has a higher mechanical resonance frequency than the first axis and may be operated on resonance as the “fast axis” of the light engine, tracing the lines of the FOV. The first axis (rotation of the inner frame 142) has a lower mechanical resonance frequency and is typically the slow axis. The slow axis may be scanned linearly with a frequency below the resonance to define a uniform line density (quasi-static operation), or operated on resonance, with simultaneous resonant operation along both axes forming a Lissajous scan pattern. The torsion springs 144, movable plate 140, and inner frame 142 may be of the same thickness or the torsion springs 144 may be thinner (for increased mechanical compliance).

Like conventional MEMS mirrors, the movable plate 140, inner frame 142, and torsion springs 144 may be formed from the Si layer of a silicon-on-insulator (SOI) wafer with ˜10-200 μm thickness. Here, additional dielectric layers are on top (for the waveguide cores 132 and claddings 134). The gratings 150 may be aligned on the movable plate 140 such that the multiple beams split the FOV along the slow axis (FIG. 1C) or along the fast axis.

FIGS. 2A and 2B show a photonic chip 200 with a coil 210 defined by on-chip metal wires 212 on the inner frame 142 of a gimbaled design; a second layer of metal wires 216 (passing over/under the first layer) is used for wiring from the inside of the coil 210 to one or more electrical pads 214 outside the inner frame 142. A substrate or carrier 202, such as a printed circuit board (PCB), supports the chip 200 and permanent magnets 220 arranged around the chip 200. These magnets 220 apply a magnetic field oriented in the chip plane and diagonal to the principal axes of the inner frame 142. Electrical current is passed through the coil 210, causing the inner frame 142 to move via the Lorentz force. Due to the orientation of the magnetic field, a component of the Lorentz force is aligned to rotate the inner frame 142 (slow axis), and a component of the force can couple to a rotational mode of the movable plate 140 (fast axis). Applying a drive signal composed of a low frequency component (slow axis frequency) and a higher frequency aligned to the resonant frequency of the movable plate 140 (fast axis) enables periodic two-dimensional (2D) scanning of the movable plate along both the fast and slow axes.

FIGS. 3A-3C and 4 show examples of movable plates with piezoelectric actuators 302. The piezoelectric actuators are formed from a piezoelectric material 304 with electrodes 306 attached to two surfaces. Electric fields applied to the piezoelectric material 304 via the electrodes 306 can cause the actuator 302 to bend or vibrate. The piezoelectric actuators 302 may be off-chip and attached to a common substrate/carrier 202 along with the photonic chip 100 as shown in FIGS. 3A-3C. In this case, vibration of the piezoelectric actuators 302 can couple to slow- and fast-axis resonances for 2D Lissajous scanning (the movable plate 140 having a gimbaled-design). Alternatively, the photonic chip may be attached to the top of the piezoelectric actuator(s) 302. Piezoelectric actuators 302 may also be integrated on the photonic chip 100, exciting mechanical resonances of gimbaled plates 140 as shown in FIG. 4 (similar to FIGS. 3A-3C).

On-chip piezoelectric actuators enable more advanced designs (FIGS. 5-7). In FIG. 5, for example, four piezoelectric cantilever actuators 502 are connected to the corners of a movable plate 540 with respective springs 544. Drive signals applied to the actuators 502 bend the cantilevers. Driving multiple piezoelectric cantilever actuators 502 can rotate the movable plate 540 along two axes (either in resonant or quasi-static mode).

FIG. 6 shows a photonic chip 600 with meandering suspended piezoelectric cantilever actuators 602 connected to a movable plate 640 with grating emitters. The operation is similar to the operation in FIG. 5, but by cascading multiple cantilevers (meandering design), the upward/downward motions of each cantilever add up.

FIGS. 7A and 7B show gimbaled photonic chips 700a and 700b, respectively, with fast axes that are operated on resonance. The gimbaled photonic chip 700a in FIG. 7A includes a movable plate 740 with grating emitters that is suspended by torsion springs 744 from an inner frame 742. The inner frame 742 is coupled, at its corners, to the rest of the photonic chip 700a by piezoelectric cantilever actuators 702a like those in FIG. 5. Likewise, the movable plate 740 in the gimbaled photonic chip 700b of FIG. 7B is suspended by torsion springs 744 from an inner frame 742. This inner frame 742 is coupled, at its corners, to the rest of the photonic chip 700b by cascaded piezoelectric cantilever actuators 702b like those in FIG. 6.

FIGS. 8-15 show slab and grating designs. In FIGS. 8A-8C, subsets of closely spaced waveguides 130 for red (R), green (G), and blue (B) light connect directly to the slab waveguide 152 (i.e., each waveguide merges with the slab, butt-coupling). The waveguides 130 may be tapered to narrow widths at the interface to enable wide divergences of the emitted beams in the slab 152. The beams coupled into the slab 152 diverge in the slab 152. After reaching beam widths close to the desired output beam diameter, the beams are coupled out of the chip by the grating 150, which has curved grating teeth. The curvature of the grating teeth is designed to match the phase front of the diverging on-axis beam in the slab 152 (for emission of a collimated or low-divergence beam). The grating teeth may have an elliptical shape. The input interface of the slab 152 may be curved (possibly with the same curvature as the grating teeth).

Off-axis subsets of input waveguides 130 are angled with respect to the center line of the grating 150/slab 152 and emit angled beams in the slab 152; the angle increases with the offset. When emitted from the grating 150, these beams are angled with respect to the on-axis beam. Overall, each beam emitted by the grating 150 addresses a slice of the FOV scanned by the photonic chip, and the offset between subsets of input waveguides 130 determines the spacing of the FOV slices. Unlike other gratings, the grating 150 in FIGS. 8A-8C uses subsets of waveguides 130 for RGB beams where the intra-subset pitch is small and the inter-subset pitch is larger.

FIGS. 8C and 9 show example cross-sections of grating teeth designs. Such designs can be used with all slab designs disclosed herein and are not exclusive to the designs in FIGS. 8A and 8B. Grating teeth may be fully etched 854a or partially etched 854b features in the slab layer 152. Gratings may further include a back-reflector 856, i.e., a reflective layer underneath the grating to reflect downward radiation from the grating, which can constructively interfere with the upwards radiation and increase the transmission. The reflector 856 may be a simple metallic mirror layer or a distributed Bragg reflector 952 formed from a stack of thin film layers.

In addition, grating teeth may be formed from fully etched or partially etched features in one or more waveguide layers above 854c or below the slab waveguide layer (these additional layer(s) being formed from the same or different materials as the slab layer). Alternatively, these additional layers of grating teeth may be formed from non-waveguide layers 854e, 950a, such as metals or Si. In other examples, the grating teeth may be formed in the cladding 854d or in a polymer material 950b, 950c on the top surface of the chip and close to the slab waveguide layer 150 (e.g., surface relief gratings 950b, possibly having a blazed design 950c). A volume holographic grating 950d may be defined on top of the slab waveguide layer 150, for example, in a polymer or photographic material. Also, the grating 950e may be laser written in the slab waveguide layer (possibly using ultraviolet light); the laser light locally modifies the refractive index of the slab 150, defining index perturbations. In another variation, a grating 950f may be defined in the waveguide layer and distributed Bragg reflectors 952 may be defined above and below the grating.

Grating apodization makes it possible to emit round, low-divergence beams. FIG. 10A shows an apodized grating 1050a. The duty cycles and lengths of the grating periods are selected to increase the grating strength along the grating, yielding a Gaussian profile of the emitted beam while ensuring the radiation from each grating period constructively interferes at the required diffraction angle of the grating. Uniform gratings (without apodization) emit beams with an exponential profile.

FIG. 10B shows a grating 1050b with 2D grating teeth features. Here, the duty cycle of the transverse grating features is designed to weaken the grating strength at the beginning of the grating 1050b, and the period of the transverse grating features is made small enough to avoid coupling to higher order modes of the slab waveguide 1052. This approach may allow a larger range of grating strengths than 1D grating features and may allow larger feature sizes to be used.

FIG. 11A shows a variation of the grating in FIG. 8 where the subsets of input waveguides 130 are positioned with small lateral and angular offsets from one another to enable interlaced beam scanning. Here, the small lateral offsets lead to small variations in the slab propagation angle of the beams (possibly corresponding to one or a small number of lines of the scan pattern). Interlaced scan patterns increase the line density and hence resolution of the display. Variations where the FOV is scanned by a set of interlaced beams are possible, in addition to variations where the FOV is addressed by sets of interlaced beams, each addressing a slice of the FOV. In the variation shown in FIG. 11B, each input waveguide 130 may guide and emit R, G, and B light into the slab 152, enabling smaller offsets between beams in the slab 152 and possibly a higher density of interlaced beams. RGB light may be multiplexed onto waveguides 130 using wavelength multiplexer devices, as in FIG. 35.

FIGS. 12A-12D show a slab and grating design for emitting multiple RGB beams. In this design, waveguides 1230 are routed toward the slab 1252 and curve along an edge of the slab 1252. As the waveguides 1230 approach the slab 1252, light evanescently couples/leaks into the slab 1252 since the slab 1252 has a higher effective index than the waveguide modes. The propagation angle in the slab 1252 is determined by a phase-matching condition involving the effective indices of the waveguide mode and slab 1252. The curvature of the waveguides 1230 defines the gaps between the waveguides 1230 and slab 1252 and hence defines the coupling strength between the waveguides 1230 and the slab 1252 as a function of position along the slab edge. The shape of the curves can be designed to apodize the coupling to the slab 1252 and enable a Gaussian beam in the slab 1252.

Unlike other designs, multiple waveguides 1230 are coupled to the slab 1252 and multiple beams are formed in the slab 1252. As shown in the cross-section in FIG. 12C, three waveguides 1230 guiding R, G, and B light are coupled to the slab 1252, and the waveguide widths and/or thicknesses are mismatched to avoid coupling between these waveguides 1230 (i.e., the effective indices of optical modes in the three waveguides at R, G, and B wavelengths are different). A subset of RGB waveguides 1230 may be coupled to a first facet of the slab 1252, and another subset of RGB waveguides 1230 may be coupled to a second facet of the slab 1252. Each subset of waveguides 1230 emits an RGB beam into the slab 1252 at an angle relative to the grating 1250, and the resultant two beams emitted from the grating 1250 are angled with respect to one another.

FIG. 12D shows an example of a simplified slab 1252′ and grating 1250′ with waveguides 1230 coupled to a single facet of the slab 1252′ and the grating 1250′ angled and aligned to the propagation axis of the beam in the slab 1252′. The grating teeth used in the designs in FIGS. 12A-12D may be like those shown in FIGS. 8-10.

FIGS. 13A-13C show additional variations of waveguides 1330a-1330c coupled to the slab; waveguides 1330a may be in layers above and below the slab 152; R, G, and B waveguides 1330b may all be in the same waveguide layer as the slab 152; and a partially-etched layer may be in the gaps between the waveguides 1330c and the slab 152 (to increase the gap required to achieve a certain coupling strength).

FIGS. 14A-14C, 15A, and 15B show additional grating and slab designs. Briefly, FIGS. 14A-14C shows a design where a lens structure 1454 is included in the slab 1452 to collimate diverging beams in the slab 1452, with a grating 1450 to couple the collimated beams out of the photonic chip. The input waveguides 130 to the slab are arranged in subsets of closely spaced waveguides to emit RGB beams.

FIG. 15A shows a design where light from a single input waveguide 1530 is expanded by a linear or nonlinear waveguide taper 1554 prior to being output by a grating 1550. FIG. 15B shows a design where a zero-order arrayed waveguide grating (AWG) is used to generate a wide beam in a slab 1552, which is subsequently output by a grating 1550. A star coupler 1560 splits light from an input waveguide 1530 into a number of output waveguides 1562, which are routed toward the slab waveguide 1552. These routed waveguides 1562 have equal optical path lengths and end in tapers 1556 that increase in width at the input to the slab 1552. By matching the optical path lengths, the light from the waveguides 1562 at the input to the slab 1552 is in phase, and due to the tapers 1556, a collimated beam with a large width can be injected into the slab 1552. The coupling strength of the star coupler 1560 to the array of waveguides 1562 can be designed to achieve an approximately Gaussian profile of the beam in the slab 1552. A grating 1550 in the slab layer couples the light out of the slab 1552. This grating 1550 may be positioned very close to the beginning of the slab 1552. This design couples one RGB beam out of the slab 1552 and can reduce the size of the overall device compared to other grating designs but may be more sensitive to fabrication variation/error. The designs in FIGS. 14A-14C may emit multiple RGB beams, whereas the designs in FIGS. 15A, and 15B each only emit a single RGB beam.

FIGS. 16-20 show variations of the photonic integrated circuit design where multiple slabs and gratings are integrated onto the movable plate. Integrating multiple gratings onto the movable plate enables FOV slicing along a second direction, i.e., the FOV is separated into a matrix of slices, each addressed by an independent beam emitted from one of the gratings. One consideration in such designs is the size of the movable plate. Large plates have low fast-axis frequencies, which may impose resolution limitations, and can suffer from increased dynamic deformation (i.e., small deformations of the plate during motion that can diminish the emitted beam quality when larger than a tenth of the wavelength). Also, the slabs add overhead to the plate size, and the plates are significantly larger than the millimeter-scale gratings. Further doubling the plate length or width to add a second grating may be impractical given the above considerations.

FIGS. 16-20 show different variations of multiple slabs and gratings in different waveguide layers that overlap one another. This enables integration of multiple gratings in a smaller plate area than might otherwise be possible with multiple gratings in a single waveguide layer. Overlapping two slabs in different layers is one approach with the advantage that the grating emissions do not interact with waveguide layers above, but the plate length or width still increases by the length of a grating. Alternatively, the slabs and gratings of upper layers may overlap the gratings of lower layers, with a small reflection expected from the slab above each grating. Gratings above other gratings may be designed to avoid significant diffraction of the beams passing through them.

FIG. 16 shows gratings 150, 150′ and slabs 152, 152′ on a movable plate 140. The gratings 150, 150′ and slabs 152, 152′ are in two or more sets of waveguide layers directly overlapping. This enables FOV splitting along a second direction (here, the fast axis).

FIG. 17 shows other gratings 150, 1750 and slabs 152, 1752 on a movable plate 140. Here, the slabs 152, 1752 in two separate layers overlap, while each grating 150, 1750 only has the cladding above it. The two gratings 150, 1750 face away from one another. As in FIG. 16, FOV splitting is enabled along a second direction.

FIG. 18 shows still other gratings 1850, 1850′ and slabs 1852, 1852′ on a movable plate. Here, the slab 1852′ of a top waveguide layer overlaps the grating 1850 of a bottom set of waveguide layers. This is another example of FOV splitting along a second direction.

FIG. 19 shows yet more gratings 150, 150′, 150″, 150′″ and slabs 152, 152′, 152″, 152′″ on a movable plate 140. Four gratings 150, 150′, 150″, 150′″ in four sets of layers are arranged such that light from the bottom three gratings 150, 150″, 150′″ passes through only slabs 152, 152′ in the upper layers. FOV splitting along a second direction is enabled by this design.

FIG. 20 shows another variation of gratings 2050, 2050′, 2050″, 2050′″ and slabs 2052, 2052′, 2052″, 2052′″ on the movable plate. Two gratings 2050, 2050′ and slabs 2052, 2052′ are defined in a top set of waveguide layers with the gratings 2050, 2050′ facing one another. Two gratings 2050″, 2050′″ and slabs 2052″, 2052′″ are defined in a bottom set of waveguide layers with the gratings 2050″, 2050′″ facing away from one another. Light emitted from the bottom gratings 2050″, 2050′″ passes through the top slabs 2052, 2052′. This enables FOV splitting along a second direction.

Since in-plane beam expansion occurs in the slab 152, the slab 152 may be non-rectangular and may taper. FIGS. 21A, 21B, 22A, and 22B show examples where the movable plate may also be non-rectangular, reducing the mass and area of the plate for higher fast-axis frequencies and less dynamic deformation. The connection point of torsion springs to the movable plate may be aligned to the center of mass of the plate to achieve rotational motion without out-of-plane up/down motion.

FIGS. 21A and 21B show photonic integrated circuit chips 2100a and 2100b, respectively, with non-rectangular movable plates 2140a and 2140b. Since light expands in the waveguide slab 152, starting from a small width and ending with a larger width, the slab 152 can be tapered. Correspondingly, the movable plates 2140a and 2140b can have non-rectangular shapes to reduce their overall mass and area. The torsion springs 144 may be positioned along an axis corresponding to the center of mass of the non-rectangular movable plate 2140a, 2140b. The grating 150 and slab 152 may be aligned relative to the non-rectangular movable plate 2140a, 2140b for FOV splitting along the fast axis (FIG. 21A) or along the slow axis (FIG. 21B).

FIGS. 22A and 22B show photonic integrated circuit variations 2200a and 2200b, respectively, with non-rectangular movable plates 2240a, 2240b, each with multiple slabs 152, 2252 and gratings 150, 2250. The non-rectangular movable plate 2240a in FIG. 22A is hexagonal and features gratings 150, 2250 that face each other. The non-rectangular movable plate 2240b in FIG. 22B is bowtie-shaped and features gratings 150, 2250 that face away from each other.

FIGS. 23A and 23B show a variation of the photonic integrated circuit chip 2300 and system including an on-chip reflector 2302 on the movable plate 140 and an off-chip reflector 2304 mounted on the waveguide combiner 108. Here, the on-chip reflector 2302 may be a thin-film metallic mirror deposited over the cladding 134 of the slab 152 region of the plate 140. Beams emitted from the grating 150 are directed back toward the on-chip reflector 2302 by the off-chip reflector 2304 and subsequently directed toward the input coupler 106 of the waveguide combiner 108. Since the grating 150 and on-chip mirror 2302 both tilt with the movable plate 140, the optical deflection angle of the beam is three times the mechanical deflection of the movable plate 140. This reduces the mechanical deflection of the movable plate 140 for a given FOV. For comparison, in systems with a conventional MEMS mirror with a fixed incident beam, the optical deflection angle is twice the mechanical deflection of the MEMS mirror. Conversely, for a movable plate with integrated slabs and gratings but without on- and off-chip reflectors, the optical deflection angle is equal to the mechanical deflection angle.

FIG. 24 shows a photonic integrated circuit chip 2400 with routing waveguides and crossings 2402 as well as waveguide polarization rotators 2404 integrated into waveguides 130 that guide one or more of the colors. Laser diode emission is typically transverse-electric (TE) polarized, while some grating designs benefit from transverse-magnetic (TM) polarized light. The waveguide polarization rotators 2404 transform TE-polarized light into TM-polarized light for higher diffraction efficiency from these gratings or reducing diffraction angle differences between shorter wavelength (e.g., blue) emitted beams and longer wavelength (e.g., green, red) emitted beams.

FIGS. 25A-25C show variations of the photonic integrated circuit chip for compensation of grating dispersion (i.e., the variation of diffraction angle with wavelength). Over the 1-2 nm typical linewidths of typical laser diodes, the diffraction angle of typical on-chip grating couplers shifts on the order of 0.1°, which limits the divergence of the emitted beam. High-resolution laser-scanning light engines have lower divergence (e.g., a 2000×2000-pixel resolution and 35°×35° FOV, which implies a divergence <35°/2000=) 0.0175°. Narrower linewidth lasers may be used to avoid this limitation (and may be achieved using optical feedback from on-chip tunable reflectors, as in FIG. 29C), but narrow linewidths can cause speckle in optical combiners (due to long laser coherence lengths).

FIGS. 25A-25C show add-ons to the photonic circuit chip that compensate the grating dispersion. The dispersion of transmission and reflection gratings can be opposite to the dispersion of waveguide-coupled gratings, i.e., the diffraction angle (relative to the chip normal) of a waveguide-coupled grating typically decreases with increasing wavelength, while the diffraction angle of a transmission grating can increase with increasing wavelength. With appropriate design of a transmission grating, the magnitude of the dispersion may match or be similar to the grating emitter dispersion, reducing the beam divergence.

FIG. 25A shows examples where a transmission grating 2502 is defined on the photonic chip (above the grating emitter) with one or more dielectric, metal, or semiconductor layers and/or grating features 2504 etched into the top surface of the cladding 134. FIG. 25B shows an example where a transmission grating 2506 may be attached to the top surface of the movable plate 140 above the grating emitter 150, and the transmission grating 2506 may be a surface relief or volume holographic grating defined in a polymer or photographic material. FIG. 25C shows an example where a reflection grating 2508 may be positioned above the photonic chip, with a design and orientation designed for cancellation of dispersion of the grating emitter 150.

FIGS. 26A and 26B show a photonic integrated circuit chip 2600 with strain sensors 2610 positioned at the connection points of torsion springs 144. For example, each strain sensor 2610 can be implemented as doped silicon 2612 arranged in a Wheatstone bridge with conductive vias 2614 at the corners that connect the doped silicon 2612 to metal wiring and pads (not shown). Each strain sensor 2610 can be made of a P++, N++, P, or N doped region of a silicon layer, e.g., in a portion 2612 of an SOI wafer surrounded by cladding 134 as shown at left in FIG. 26B or in a portion 2612′ of the silicon substrate 110 of the photonic chip. In operation, the strain sensors 2610 provide a measure of the deflection of the movable plate 140 for control of the system.

FIG. 27 illustrates a photonic integrated circuit chip 2700 with thermal actuators 2702 and/or piezoelectric actuators 2702′ embedded in the cladding 134 on the inner frame 142 and on the movable plate 140. The actuators 2702, 2702′ compensate for out-of-plane curvature caused by material stresses from the deposited dielectric layers on the chip 2700 (for waveguide cores 132 and cladding 134). The piezoelectric actuators 2702′ may be formed of piezoelectric material 304 sandwiched between metal layers 306 for applying an electric field to the piezoelectric material 304 as shown at lower right in FIG. 27. The thermal actuators 2702 may include a metal layer 2708 near a (resistive) heater 2710 that heats metal layer 2708, causing the metal layer 2708 to expand and/or bend.

As described above, flip-chip bonding can be used to couple laser chips 120 to photonic integrated circuit chips 100. Other possibilities are shown in FIGS. 28A-28C. In FIG. 28A, laser chips 120 are aligned to edge couplers 2804 on a photonic chip 2800a, and both the laser chips 120 and the photonic chip 2800a are attached to a common substrate/carrier 2802a. The laser chips 120 and the photonic chip 2800a may be attached to the substrate 2802a face-up or flip-chip bonded. In FIG. 28B, the laser chips 120 are coupled to edge couplers in a photonic chip 2800b through small optics 2804 (e.g., lenses) that are also attached to the common substrate/carrier 2802b. FIG. 28C shows a photonic chip 2800c with laser array chips 2820 (with a lithographically defined pitch) instead of individual laser chips to alleviate packaging challenges associated with aligning many laser chips to the photonic integrated circuit chip 2800c. In butt-coupling approaches (e.g., FIGS. 1, 28A, and 28C), efficient optical coupling involves matching of the optical waveguide mode of each edge coupler of the photonic chip to the waveguide mode of the corresponding laser chip.

FIGS. 29A-29C show additional possibilities for coupling laser chips to a photonic integrated circuit chip. In FIG. 29A, the laser chips 120 and photonic chip 2900a are mated to a common carrier/substrate 2902. Edge couplers 2904 on 1D, 2D, or 3D actuators, all integrated with the photonic chip 2900a, couple light from the laser chips 120 into waveguides 130 integrated with the photonic chip 2900a. In FIG. 29B, the laser chips 120 and the actuator-mounted edge couplers 2904 are integrated directly with the photonic chip 2900b itself. In both cases, the actuators may be used to translate and/or tilt the input edge couplers 2904 to optimize the alignment of the edge couplers 2904 to the lasers 120.

FIG. 29C shows a variation of the laser coupling where tunable waveguide reflectors 2910 on the photonic integrated circuit chip 2900c provide feedback to the laser chips 120. The tunable reflectors 2910 may be tunable in amplitude, reflection spectrum, and/or phase. An example of such a reflector 2910 is an add-drop ring resonator 2912 with a waveguide loop mirror 2916 at the drop port; tuning the ring resonator 2912 changes the wavelength of maximum reflectivity and tuning the phase shifter 2914 between the edge coupler 2902′ and ring resonator 2912 tunes the phase of the reflected light. Tunable feedback to the corresponding laser 120 enables tuning of the wavelength, linewidth, and stability of that laser 120.

In photonic integrated circuit chips with flip-chip bonded lasers (e.g., as in FIG. 1A), the lasers may be placed in trenches defined in the wafer substrate surface. These trenches may have pillars defined in them that serve as mechanical stops for accurate height alignment of the laser core and edge coupler when placing the chip (self-alignment). These trenches may also contain on-chip wiring and solder bumps for soldering the laser in place and applying electrical signals to the laser.

FIG. 30 shows a photonic integrated circuit chip 3000 with a laser coupling portion that uses waveguide power taps 3004 (e.g., multimode interference couplers or evanescent directional couplers) to couple small fractions of the light in the waveguides 130 to respective on-chip waveguide-coupled photodetectors 3006 for monitoring the power and intensity modulation of the lasers 120. Such a waveguide-coupled photodetector 3006 may include a waveguide (e.g., made of SiN or Al₂O₃) passing over a patch or mesa of doped Si, wherein a PIN or PN junction is defined. FIG. 30 also shows that temperature sensors 3008 may be defined on the photonic integrated circuit chip 3000 in close proximity to the lasers 120. Temperature sensors 3008 can be used for ensuring a stable operating temperature (and wavelength) of the lasers 120. Temperature sensors 3008 may be formed from thin film metal wires or doped Si wires formed on the photonic chip (in both cases, the electrical resistance changes with temperature, providing a measure of temperature).

FIGS. 31A-31C show examples of actuators suitable for use in inventive photonic chips. Such actuators may be based on electro-thermal or piezoelectric actuation and may include suspended cantilevers containing the edge couplers or cascaded cantilever actuators for linear translation of a bridge containing the edge couplers. Cascaded cantilever actuators can perform large vertical and in-plane translation. An actuator formed from a single cantilever with a waveguide can be used for aligning to a laser and a fiber. Following alignment using the actuator, epoxy may be applied to the actuator to fix its position.

FIG. 31A illustrates a 1D suspended cantilever actuator 3100a with one or more embedded edge coupler(s) 3102 for aligning the edge couplers 3102 to lasers (not shown) in or coupled to an inventive photonic chip. The 1D suspended cantilever actuator 3100a includes a suspended cantilever 3104 with an actuator 3106 that bends the cantilever 3104, tilting and/or translating the actuator 3106 out of the chip plane. The actuator 3100a may be a piezoelectric or electrothermal actuator as described above with respect to FIG. 27.

FIG. 31B shows another 1D suspended cantilever actuators 3100b with multiple suspended cantilevers 3104, each with its own actuator 3106, coupled to a bridge with extensions 3108, each of which contains one or more edge couplers 3102. The multiple cantilevers 3106 may increase the robustness of the suspended structure.

FIG. 31C shows a 2D actuator 3100c (up/down and in-plane/out-of-plane in the illustration) based on cascaded cantilever actuators 3112 (e.g., using piezoelectric or electrothermal mechanisms like those described above). One or more actuators for each actuation direction are connected to a suspended bridge 3114 with extensions 3108 containing the edge coupler(s) 3102. Cascaded cantilever actuators 3112 enable larger translations than simple cantilever actuators, and additionally, can be designed to translate without tilting.

FIGS. 32 and 33 show variations of edge couplers that may be used to couple light from the laser chips to the photonic integrated circuit chip. The edge couplers are designed such that the optical mode at the tip of the edge coupler closely matches the transverse optical mode of the corresponding laser chip. FIGS. 32 and 33 show single-layer and bi-layer edge couplers in addition to tapered and inverse-tapered designs.

More specifically, FIG. 32 shows a single-layer tapered edge coupler 3202, single-layer inverse tapered edge coupler 3200, bi-layer tapered edge coupler 3206, and bi-layer inverse tapered edge coupler 3204. Single-layer edge couplers 3200, 3202 (top) have waveguide cores 132, 3232′ that increase or decrease the width of the waveguide 130 as it approaches the facet of the photonic chip (and are terminated with a blunt tip where light is coupled into the waveguide 130 at the chip facet). Bi-layer edge couplers 3204, 3206 (bottom) include inter-layer transitions where overlapping tapers between two waveguide layers 132, 3232″ enable light to transfer between the layers; a thicker waveguide 132 (useful for compact on-chip photonic devices and dense waveguide routing) is coupled to a thinner waveguide layer 3232″ with lower optical confinement (more ideal for engineering the optical mode for input coupling from lasers). Both tapered and inverse tapered edge couplers can function as the input edge couplers (for laser coupling) of an inventive photonic chip.

FIG. 33 shows edge couplers 3302, 3304 using partial and full etch steps (two-step etch) of a single waveguide layer 132 to define a thin waveguide for coupling light on the chip and a thicker waveguide 3332 for compact photonic devices and dense waveguide routing away from the facet.

FIGS. 34-36 show additional photonic integrated circuit variations. In FIGS. 34A and 34B, on-chip optical switches 3410 route light from the waveguides 130 coupled to the lasers 120 to a larger number of waveguides 130 that couple to the slabs 152 and gratings 150. This enables a scheme where the FOV is addressed in sub-frames where the slow-axis deflection can decrease by a factor of the (number of subsets of waveguides input to slab/number of lasers per color) at the expense of a correspondingly higher slow axis frequency.

More specifically, FIG. 34A illustrates a photonic integrated circuit chip 3400 with optical switches 3410, shown as cascaded 1×2 Mach Zehnder interferometers (MZIs) 3402, connected to each laser 120. Each MZI 3402 has a phase shifter in one of the arms (e.g., thermo-optic phase shifter with a thin film heater above the waveguide), and the phase shifter is driven with an electrical signal to switch the input between the two outputs. The number of waveguide subsets coupled to the slab 152 is larger than the number of lasers 120 per color, and the switches 3410 route laser light to the waveguides 130.

FIG. 34B illustrates the multiplexing scheme for the photonic chip of FIG. 34A. Each frame of the display is divided into a number of sequential sub-frames, each corresponding to a set of waveguides coupled to the slab selected by the optical switches. The frame is complete after all waveguides have been addressed and their respective output beams have scanned their FOV slices.

FIG. 35 shows a photonic chip 3500 that uses waveguide crossing 3502 and on-chip RGB wavelength multiplexers 3504 to combine light from one set of R, G, and B lasers 120 onto each waveguide 3530 coupled to the slab waveguide 152. The emitted light from each waveguide 3530 coupled to the slab waveguide 152 includes co-axial R, G, and B beams, in contrast to FIG. 1A, which uses a separate waveguide 130 for each R, G, and B beam. This approach may reduce or eliminate the offset between R, G, and B beams in FIGS. 1A-1C, at the expense of additional photonic integrated circuit complexity and optical loss. The wavelength multiplexers 3504 may be arrayed waveguide gratings, evanescent directional couplers, ring resonators, or echelle gratings.

FIG. 36 shows a photonic chip 3600 with on-chip splitting devices (power splitters) 3602 that split the light from each laser 120 into a number of waveguides 130, each connected to an on-chip high-speed intensity modulator 3604, which modulates the intensity of each beam, rather than directly modulating the lasers 120. The optical splitting devices 3602 may be cascaded 1×2 multimode interferometer or evanescent directional coupler splitters. These intensity modulators 3604 may operate at modulation rates of about 100-500 MHz. The modulators may be formed from microelectromechanical (MEMS) phase shifter devices, semiconductors such as gallium nitride (GaN), or electro-optic materials such as barium titanate (BTO), lithium niobate, or lithium tantalate. Additional direct modulation of the lasers may be used to turn off the laser in empty regions of the image.

FIGS. 37 and 38 show photonic integrated circuit chips 3700 and 3800, respectively, where the slab(s) 152 and grating(s) 150 are not on a movable plate. Instead, each system has a two-axis MEMS mirror (either integrated onto the photonic chip or on a separate chip) that scans the beams. For the case of an integrated MEMS mirror, an external reflector above the chip redirects the beam(s) emitted by the photonic chip to the integrated MEMS mirror.

In FIG. 37, the beam(s) emitted by the grating(s) 150 on the photonic chip 3700 are reflected off an external reflector 3702 (e.g., a mirror or grating) and directed towards a 2-axis MEMS mirror chip 3706. Both the photonic chip 3700 and the 2-axis MEMS mirror chip 3706 are attached to a common carrier/substrate 202. The 2-axis MEMS mirror chip 3706 includes an on-chip reflector (MEMS mirror) 3704, such as a metal mirror, mounted on a movable plate 3740 suspended from an inner frame 3742 by torsion springs 3744. This inner frame 3742 is itself suspended from the MEMS mirror chip 3706 by another set of torsion springs 3744 to provide two-axis gimbaled motion of the on-chip reflector 3704.

In operation, the MEMS mirror 3706 scans and directs the beam(s) to the input coupler of an optical combiner. Beams emitted at different angles from the grating 150 shift laterally as they propagate through the system. This limits the range of beam angles that may be used if multiple beams are emitted from the photonic chip 3700. Differences in the diffraction angles of R, G, and B beams may be corrected, e.g., by including spacers 3710 and wavelength-selective reflectors 3712 (e.g., dichroic mirrors) that are tilted with respect to one another (top-right) in the off-chip reflector 3702. The spacers 3710 correct for lateral shifts, and the tilt angles of the reflectors 3712 correct for differences in the diffraction angle of R, G, and B light.

FIG. 38 illustrates a photonic integrated circuit chip 3800 with an integrated 2-axis MEMS mirror 3806. The 2-axis MEMS mirror 3806 includes an on-chip reflector 3804, such as a metal mirror, mounted on a movable plate 3840 suspended from an inner frame 3842 by torsion springs 3844. This inner frame 3742 is itself suspended from the photonic chip 3800 by another set of torsion springs 3844 to provide two-axis gimbaled motion of the on-chip reflector 3804. Similar to the photonic chip 3700 in FIG. 37, light emitted by the grating(s) 150 is reflected by an external reflector 3702 toward the on-chip MEMS mirror 3804. The MEMS mirror 3804 scans the beam(s) and directs them to the input coupler 106 of the waveguide combiner 108. Similar to FIG. 37, the off-chip reflector 3702 may be configured to compensate for differences in the R, G, and B emission angles from the grating(s) 150.

FIGS. 39A-39C show light engines based on these concepts together with a waveguide combiner 108. Grating dispersion and diffraction angle differences between R, G, and B light may lead to significant lateral offsets between R, G, and B beams before reaching the input coupler 106 of the waveguide combiner 108. The off-chip reflector may align R, G, and B beams to compensate for wavelength-dependent dispersion and/or diffraction.

The light engine in FIG. 39A includes a photonic integrated circuit chip 3900a without a movable plate. This photonic chip 3900a mounted next to a single-axis MEMS mirror chip 3906a on a common carrier/PCB 202. The grating 150 couples beams out of the photonic chip 3900a to another single-axis MEMS mirror chip 3902, which scans the beams in a first direction (e.g., into and out of the plane of the figure) across the single-axis MEMS mirror chip 3906a, which scans the beams in a second direction (e.g., in the plane of the figure; orthogonal to the first direction). The input coupler 106 receives the scanned beams, which propagate through the waveguide combiner 108 to the output coupler 110.

The light engine in FIG. 39B includes a photonic integrated circuit chip 3900b without a movable plate and with an integrated single-axis MEMS mirror 3906b. The grating 150 couples beams out of the photonic chip 3900b to another single-axis MEMS mirror chip 3902, which scans the beams in a first direction (e.g., into and out of the plane of the figure) across the single-axis MEMS mirror on the photonic chip 3906b, which scans the beams in a second direction (e.g., in the plane of the figure; orthogonal to the first direction). The input coupler 106 receives the scanned beams, which propagate through the waveguide combiner 108 to the output coupler 110.

The light engine in FIG. 39C includes a photonic integrated circuit chip 3900c without a movable plate or an integrated single-axis MEMS mirror. In this light engine, the grating 150 couples beams out of the photonic chip 3900c to a two-axis MEMS mirror chip 3910, which scans the beams in two directions across the input coupler 106. The input coupler 106 couples the scanned beams into the waveguide combiner 108, which guides them the output coupler 110.

### LiDAR Systems

FIG. 40 shows three LiDAR techniques compatible with laser scanning. In time-of-flight pulsed LiDAR (top), at each position of the beam, an optical pulse is emitted and the time delay in receiving a reflected (echo) pulse from an object enables calculation of the object's depth or distance from the optical pulse source. In amplitude-modulated coherent-wave (AMCW) LiDAR (middle), the amplitude of the beam is modulated periodically, and the phase difference of the amplitude modulation between the transmitted light and received reflected light enables calculation of the object's depth or distance. Lastly, in frequency-modulated coherent-wave (FMCW) LiDAR (bottom), the optical frequency of the laser is modulated periodically, and the frequency difference between transmitted light and received reflected light is used to calculate the depth of or distance to an object. With each method, as the laser beam is scanned across a scene, depth information can be extracted for every beam position.

FMCW LiDAR is often implemented by interfering the received reflected light and a portion of the laser light tapped off before transmission (referred to as the local oscillator (LO) beam). The interference may be performed with a beam splitter or other 2×2 optical coupler, and the two resultant outputs are detected with balanced photodetectors (coherent detection). An optical frequency difference between the LO and the reflected light leads to a beat signal in the photocurrent output of the balanced photodetectors, and the beat frequency is used to calculate the depth. AMCW may be performed with coherent detection or by detecting the reflected light with a single photodetector and extracting the phase shift of the amplitude modulation with electronic circuits. Time-of-flight pulsed LiDAR is performed by detecting the reflected pulse with a single photodetector.

FIG. 41 shows a photonic integrated circuit chip 4100 for FMCW or AMCW LiDAR with coherent detection (it is especially well-suited for FMCW LiDAR). Like the light engines for displays, this photonic chip 4100 has one or more slabs 152 and gratings 150 integrated onto a movable plate 140. Here, the photonic chip 4100 has operating wavelengths in the near-infrared (NIR) portion of the electromagnetic spectrum (e.g., wavelengths of 850 nm, 905 nm, 940 nm, and 1550 nm), so NIR lasers 4120 are flip-chip bonded onto or otherwise co-packaged with the photonic chip 4100. The wavelengths of the lasers 4120 do not have to be identical, and in some embodiments, the wavelengths of the lasers 4120 may be different to limit crosstalk between reflected beams received by the photonic chip. In embodiments using wavelengths longer than about 1100 nm (e.g., 1550 nm), Si (e.g., using the Si device layer of a silicon-on-insulator wafer) may be used as the waveguide core, waveguide slab, and/or grating materials.

The NIR beams emitted by the NIR lasers 4120 can be modulated in amplitude or frequency by driving the NIR lasers 4120 directly or with external modulators (not shown). Waveguides 4130 guide the modulated NIR beams from the NIR lasers 4120 to tunable on-chip reflectors 4110 (e.g., like those described above with respect to FIG. 29C), which are used to provide optical feedback to the NIR lasers 4120 for achieving narrow linewidths. The on-chip reflectors 4110 reflect portions of the modulated beams back to the NIR lasers 4120. This helps to ensure that the NIR lasers' coherence lengths are significantly larger than twice the maximum depth measured. They also couple portions of the modulated beams to frequency discriminators 4112 that monitor the beams' optical wavelength(s), and, with control electronics (not shown), enable stabilization and tracking of the beams' optical frequency.

A 1×2 coupler couples off a portion of the modulated beam from each NIR laser 4120 to a separate set of waveguides to form the local oscillators (LOs). The waveguides 4130 guide the rest of each modulated beam to the grating 150 via the slab waveguide 152 (with 2×2 couplers splitting portions of the beams off to photodetectors for power monitoring). As explained in greater detail below with respect to FIGS. 43A and 43B, the grating(s) 150 emit collimated (or low-divergence) beams, which are scanned across the scene by the movable plate 140. Beams reflected or scattered from the scene follow the same path backwards and are coupled back into the waveguides 4130 via the grating(s) 150 from which they were emitted. A portion of the reflected light in each waveguide 4130 is coupled into a separate set of waveguides by 2×2 couplers, which interfere the reflected light with the LOs. On-chip balanced photodetectors 4114 coupled to the outputs of the 2×2 couplers detect this interference. The photodetectors 4114 may be waveguide-coupled Si photodetectors, which can detect light at wavelengths less than about 1000 nm. For wavelengths longer than about 1100 nm (e.g., 1550 nm), the photodetectors 4114 may be waveguide-coupled germanium photodetectors.

FIG. 42 shows a photonic integrated circuit chip 4200 for time-of-flight pulsed LiDAR or AMCW LiDAR (without coherent detection). Like the photonic integrated circuit chip 4100 in FIG. 41, the photonic integrated circuit chip 4200 in FIG. 42 features directly modulated NIR lasers 4120 that generate (amplitude- or pulse-) modulated NIR beams that are emitted from a grating 150 and scanned across the scene with a movable plate 140. The grating 150 couples beams reflected and/or scattered from the scene back into the waveguides 4130, which route them via 2×2 couplers to photodetectors 4202 that detect the reflected and/or scattered beams. (The 2×2 couplers 4200 also couple portions of the outgoing beams to photodetectors 4204 that monitor the beams' output power.) The power levels of the transmitted and reflected beams detected by these photodetectors 4202, 4204 can be compared in the electronic domain by circuitry and/or a processor (not shown) to provide an indication of the range from the LiDAR to the scene.

Some embodiments of the photonic chips may include tunable optical filters connected to the photodetectors to filter the reflected light (not shown in FIG. 42). These tunable optical filters may be used to preferentially transmit light at the wavelengths of the NIR lasers and reject ambient light coupled into the photonic chip via the grating(s). The tunable optical filters may be implemented as cascaded add-drop ring resonator filters, photonic crystal filters, evanescent directional couplers, echelle gratings, arrayed waveguide gratings, or corrugated sidewall grating filters. Integrated resistive heaters positioned above or laterally offset from the filter devices may be used to thermo-optically tune the filters to align the transmission spectra of the filters to the NIR laser wavelengths. In other embodiments, the waveguides receiving the reflected light from the gratings via the slabs may be separate waveguides with small lateral offsets from the corresponding waveguides transmitting light into the slab, grating, and then free space. In this case, the tunable optical filters and photodetectors can be directly connected to each receiving waveguide.

FIGS. 43A and 43B show photonic integrated circuit chips 4300a and 4300b, respectively, used for LiDAR. Each photonic chip may include a reflector on the movable plate (e.g., thin film metal mirror over the slab region of the plate) and an external reflector, and in this approach, the optical deflection angle is three times the mechanical deflection of the movable plate.

FIG. 43A illustrates a photonic integrated circuit chip 4300a being used for LiDAR, with NIR beams emitted by the grating(s) 150 on the movable plate 140 scanned across a scene by the movable plate 140. At each position of the plate, reflections of the beams from objects in the scene are coupled back into the photonic chip 4300a via their respective grating coupler(s) 150. Waveguides in the photonic chip 4300a couple the reflected beams to a receiver photonic circuit 4302 (e.g., balanced photodetector) integrated with the photonic chip 4300a.

FIG. 43B shows a LiDAR system with an off-chip reflector 4306 and a reflector 4304 integrated onto the movable plate 140 (e.g., a metal mirror above the waveguide slab region of the plate). The transmitted beams from the grating(s) 150 are reflected by the off-chip mirror 4306, directed toward the reflector 4304 on the movable plate 140, and reflected toward the scene. The movable plate 140 scans the beams, and the deflection of the optical beam is three times the deflection of the movable plate 140. Reflected beams from the scene pass through the same paths back to the photonic chip 4300b and are coupled into a receiver photonic circuit 4302 in the photonic chip 4300b via their respective grating coupler(s) 150.

Like the light-engine system shown in FIGS. 37 and 38, additional variations for LiDAR include photonic chips with slabs and gratings not on a movable plate. Instead, the beams are scanned by a two-axis MEMS mirror integrated onto the photonic chip or on a separate chip. The beams may also be scanned by two one-axis MEMS mirrors (each on a separate chip or one on a separate chip and one integrated onto the photonic chip).

FIG. 44 shows some of these LiDAR system variations. Here, the gratings 150 and slabs 152 on the photonic chips 4400a, 4400b are not integrated onto a movable plate. (Top left) One or more beams from the grating 150 are directed by an off-chip reflector 4402 toward a 2-axis MEMS mirror 4404 integrated onto the photonic chip 4400a. The MEMS mirror 4404 scans the beams. (Bottom left) The 2-axis MEMS mirror 4414 is on a separate chip mounted on the same common substrate/carrier 202 with the photonic chip 4400b. (Top right) Two separate 1-axis MEMS mirror chips 4406, 4408 are used to scan the emitted beams from the photonic chip 4400b. (Bottom right) One 2-axis MEMS mirror chip 4418 with an on-chip reflector 4420 is positioned above the photonic chip 4400b and used to scan the beams. In all cases, reflected beams pass backward through the system and are coupled onto the photonic chip 4400a, 4400b via their respective grating coupler(s) 150.

Other embodiments of LiDAR optical systems may include separate transmitter and receiver modules. The transmitter and receiver modules may have the same configurations as in FIGS. 43A, 43B, and 44. During operation the movable plates and/or scanning mirrors of the two modules may be synchronized so that as the transmitter scans beams across a scene, reflected light is coupled into corresponding waveguides on the receiver photonic integrated circuit.

The photonic integrated circuit chips for LiDAR systems can also include the variations using details described above with respect to FIGS. 1-36, e.g., laser, photodetector, thermal sensor, strain sensor, grating, slab, movable plate, actuator, and edge coupler variations, embodiments with optical switches and/or modulators, and variations with actuators on the movable plate to compensate for deposited thin film stress.

Systems with Simultaneous Light Engine and LiDAR Functionalities Augmented reality glasses can use both display and 3D imaging functionalities. FIG. 45A-45C show optical systems based on photonic integrated circuits with simultaneous light engine and LiDAR functionalities.

FIG. 45A shows a photonic chip 4500 for simultaneous light engine and LiDAR functionalities, with some circuit elements and the routing waveguides omitted for clarity. It includes directly modulated R, G, B, and NIR lasers 120, 4120 flip-chip bonded onto or otherwise co-packaged with the photonic chip 4500. Subsets of R, G, B, and NIR waveguides (not shown) couple light to one or more slabs 152 for in-plane beam expansion and one or more gratings 150 emit the beams out of the photonic chip 4500. The grating(s) 150 and slab(s) 152 are integrated onto a movable plate 140, which steers the RGB and NIR beams in 2D. In addition, reflected NIR light is collected by the gratings 150 and detected by photonic circuitry on the chip. Tunable reflectors 4502, frequency discriminators, and receiver circuits (e.g., balanced photodetectors 4302) on the chip enable time-of-flight, AMCW, or FMCW LiDAR.

FIGS. 45B and 45C show different configurations of the photonic chip 4500 of FIG. 45A positioned close to the input coupler 106 of a waveguide combiner 108. Scanned RGB beams are coupled into the waveguide combiner 108, while scanned NIR beams pass through the waveguide combiner 108 and are scanned across the scene. Reflected NIR beams pass through the waveguide combiner 108, are coupled back onto the photonic chip 4500 via their respective grating(s) 150 and detected (either with individual or balanced on-chip photodetectors). Additional optical elements may be placed on the outside of the waveguide combiner and in the path of the NIR beams to correct for aberrations and/or distortions in the NIR beams or widen the scan angle (FOV) of the NIR beams (at the expense of increasing beam divergence) (not shown in FIGS. 45B and 45C).

FIG. 46 shows a photonic integrated circuit chip and system configuration with gratings 4602 and slabs (not shown) arranged along a curve on the photonic chip. The curve and emission angles of the gratings 4602 are selected such that the beams can be reflected by an off-chip reflector 4604 above the chip and directed toward a 2-axis MEMS mirror 4606 either integrated onto the photonic chip or on a separate chip (top-right). The MEMS mirror 4606 scans the beams and directs them toward the input coupler 4608 of an optical combiner. Alternatively, the external MEMS mirror 4606 may be positioned above the photonic chip (bottom-right). The beams may directly overlap at the MEMS mirror plane or directly overlap at a plane slightly above the MEMS mirror plane (close to or at the input coupler plane).

### Configuration, Fabrication, and Substrate Details

The photonic chips described herein may be fabricated on a number of wafer substrates. The chips may be fabricated on bulk Si, silicon on insulator (SOI), or double SOI wafers. SOI wafers may further be divided into wafers with a thin Si device layer (thickness <1 μm, often used for Si photonics applications) and wafers with a thick Si device layer (thickness about 5-150 μm, often used for MEMS applications). Trenches may be etched into the front of the wafer to define the shapes of the movable plate (or integrated MEMS mirror), torsion springs, and edge coupler facets. The whole wafer may be thinned (e.g., by back grinding or etching) to thin and separate the chips from the wafer (resulting in chips with a uniform thickness). Alternatively, the backside of the wafer may be patterned with trenches to selectively thin the torsion springs and movable plate (or integrated MEMS mirror).

As mentioned above, the overhead on movable plate size due to the slab waveguide leads to plate sizes larger than the emitted beam diameter. Dynamic deformation due to the plate size may be addressed using known methods for MEMS mirrors. For example, ridges may be patterned onto the back of the movable plate such that the movable plate is effectively thicker (and more resistant to dynamic deformation) without incurring the same increase in mass as if the movable plate had a large uniform thickness. In addition, curvature of the movable plate (due to stresses of the dielectric waveguide and cladding layers deposited on top) may be compensated by the stress of a dielectric layer on the back of the movable plate.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A photonic integrated circuit chip comprising:
a substrate;
a movable plate suspended from the substrate and configured to tilt about a first axis with respect to the substrate and about a second axis with respect to the substrate;
an array of lasers, integrated with the substrate, to emit red light, blue light, and green light;
an array of waveguides, integrated with the substrate in optical communication with the array of lasers, to guide the red light, the blue light, and the green light to the movable plate;
a slab waveguide, integrated with the movable plate, to guide the red light, the green light, and the blue light from the array of waveguides;
a grating, integrated with the movable plate in optical communication with the slab waveguide, to emit the red light, the green light, and the blue light into free space; and
at least one actuator, operably coupled to the movable plate, to tilt the movable plate about the first axis and about the second axis so as to scan the red light, the green light, and the blue light across at least a portion of a field of view.

2. The photonic integrated circuit chip of claim 1, wherein the substrate forms an outer frame around the movable plate, and further comprising:
an inner frame suspended from the substrate and configured to tilt about the first axis with respect to the substrate,
wherein the movable plate is suspended from the inner frame and configured to tilt about the second axis with respect to the substrate and the inner frame.

3. The photonic integrated circuit chip of claim 2, further comprising:
a conductive coil, integrated with the inner frame, to cause two-dimensional rotation of the movable plate via the Lorentz force in response to a current.

4. The photonic integrated circuit chip of claim 2, further comprising:
inner torsion springs mechanically coupling the movable plate to the inner frame; and
outer torsion springs mechanically coupling the inner frame to the outer frame.

5. The photonic integrated circuit chip of claim 1, wherein the slab waveguide is configured to form the red light in multiple beams of red light, the green light into multiple beams of green light, and the blue light into multiple beams of blue light.

6. The photonic integrated circuit chip of claim 5, wherein the grating is configured to emit the multiple beams of red light, the multiple beams of green light, and the multiple beams of blue light into free space and the at least one actuator and the movable plate are configured to scan the multiple beams of red light, the multiple beams of green light, and the multiple beams of blue light across different slices of the field of view.

7. The photonic integrated circuit chip of claim 1, wherein the grating is an apodized grating.

8. The photonic integrated circuit chip of claim 1, wherein the grating is curved in a plane of the movable plate.

9. The photonic integrated circuit chip of claim 1, wherein the grating is configured to emit the red light, the green light, and the blue light as collimated beams.

10. The photonic integrated circuit chip of claim 1, wherein the grating comprises:
cladding material;
a first layer of grating teeth, embedded in the cladding material, to diffract first portions of the red light, the blue light, and the green light into free space at first angles with respect to the movable plate; and
a second layer of grating teeth, embedded in the cladding material, to diffract second portions of the red light, the blue light, and the green light into free space at second angles with respect to the movable plate.

11. The photonic integrated circuit chip of claim 1, wherein the slab waveguide is a first slab waveguide configured to guide first portions of the red light, the green light, and the blue light, the grating is a first grating configured to emit first portions of the red light, the green light, and the blue light into free space in first directions, and further comprising:
a second slab waveguide, integrated with the movable plate in optical communication with the array of waveguides, to guide second portions of the red light, the green light, and the blue light; and
a second grating, integrated with the movable plate in optical communication with the second slab waveguide, to emit the second portions of the red light, the green light, and the blue light into free space in second directions.

12. The photonic integrated circuit chip of claim 11, wherein the first slab waveguide overlaps the second slab waveguide.

13. The photonic integrated circuit chip of claim 12, wherein the first grating overlaps the second grating.

14. The photonic integrated circuit chip of claim 1, wherein the at least one actuator comprises:
cantilevered piezoelectric actuators coupling the movable plate to the substrate and configured to rotate the movable plate about the first axis and the second axis.

15. The photonic integrated circuit chip of claim 1, wherein the array of lasers is further configured to emit infrared light, the array of waveguides is configured to guide the infrared light to the movable plate, the slab waveguide is configured to guide the infrared light to the grating, and the grating is configured to emit the infrared light into free space, and further comprising:
at least one photodetector, in optical communication with the grating, to detect returned infrared light from an object illuminated by the infrared light.

16. A light engine for an augmented reality display, the light engine comprising:
the photonic integrated circuit chip of claim 1; and
an optical combiner, in optical communication with the photonic integrated circuit chip, to direct the red light, the green light, and the blue light emitted into free space by the grating toward an eye of a person viewing the augmented reality display.

17. The light engine of claim 16, wherein the array of lasers is further configured to emit infrared light, the array of waveguides is configured to guide the infrared light to the movable plate, the slab waveguide is configured to guide the infrared light to the grating, and the grating is configured to emit the infrared light into free space, and the optical combiner is configured to transmit the infrared light onto a scene, and further comprising:
at least one photodetector to detect returned infrared light from the scene.

18. A light engine for an augmented reality display, the light engine comprising:
the photonic integrated circuit chip of claim 1; and
a mirror, in optical communication with the grating, to reflect the red light, the green light, and the blue light.

19. A photonic integrated circuit chip comprising:
a substrate;
a movable plate suspended from the substrate and configured to tilt about a first axis with respect to the substrate and about a second axis with respect to the substrate;
an array of lasers, integrated with the substrate, to emit infrared light;
an array of waveguides, integrated with the substrate in optical communication with the array of lasers, to guide the infrared light to the movable plate;
a slab waveguide, integrated with the movable plate, to guide the infrared light from the array of waveguides;
a grating, integrated with the movable plate in optical communication with the slab waveguide, to emit the infrared light into free space;
at least one actuator, operably coupled to the movable plate, to tilt the movable plate about the first axis and about the second axis so as to scan the infrared light across at least a portion of a field of view; and
at least one photodetector, in optical communication with the grating, to detect returned infrared light from an object illuminated by the infrared light.

20. A LiDAR system comprising:
the photonic integrated circuit chip of claim 19; and
a mirror, in optical communication with the grating, to reflect the infrared light.
